(19) United States
(12) Patent Application Publication
(10) Pub. No.: US 2025/0351228 A1
(43) Pub. Date: Nov. 13, 2025

(54) TELEPHONY DEVICES FOR PUBLIC SAFETY ANSWERING POINTS

(71) Applicant: Intrado Life & Safety, Inc., Longmont, CO (US)

(72) Inventor: Chantal Bunnett, Quebec (CA)

(21) Appl. No.: 18/662,001

(22) Filed: May 13, 2024

Related U.S. Application Data
(63) Continuation of application No. 18/648,141, filed on Apr. 26, 2024.

(51) Int. Cl. H04W 76/50; H04M 3/51; H04W 64/00

(52) U.S. Cl. CPC H04W 76/50; H04W 64/006; H04M 3/5116

(57) ABSTRACT

A method is implemented by a device and includes receiving a position ID; determining whether a first input was received on a first pad of the device within a predetermined period of the receiving; transmitting a device communication request via a first wireless connection of the device, wherein the communication request indicates the position ID; and receiving, via the first wireless connection, a communication response including audio of a telephone call.

### RELATED APPLICATION

This application is a continuation (and claims the benefit of priority under 35 U.S.C. § 120) of U.S. application Ser. No. 18/648,141, filed on Apr. 26, 2024, entitled “TELEPHONY DEVICES FOR PUBLIC SAFETY ANSWERING POINTS,” Inventor Chantal Bunnett. The disclosure of that application is considered part of and is incorporated in its entirety by reference in the disclosure of this application.

### BACKGROUND

### Technical Field

This disclosure relates to devices for telephonic communication and, in particular, to a wireless accessory for a telephone and to a telephone cradle.

### Related Art

With staffing shortages at a critical level in 911 Public Safety Answering Points (PSAPs) across North America, supervisors are often pulling double duty. They are walking around supervising call takers, but they are also assisting with taking both 911 and administrative calls.

### BRIEF SUMMARY

In a first implementation of the present disclosure, a method includes receiving a position ID; determining whether a first input was received on a first pad of the device within a predetermined period of the receiving; transmitting a device communication request via a first wireless connection of the device, wherein the device communication request indicates the position ID; and receiving, via the first wireless connection, a communication response including audio of a telephone call.

In a second implementation, a method includes receiving a communication request via a wireless connection, wherein the communication request indicates a position of a telephone call and a device ID; determining whether the device ID matches a predetermined device ID; and transmitting, via the wireless connection, a communication response to the communication request, the communication response including audio of the telephone call.

In a third implementation, a method includes receiving a supervisor ID via a first wireless technology; determining whether a device ID of a second device was received via a second wireless technology; and transmitting a position communication request via the first wireless technology, the communication request indicating the device ID, the supervisor ID, and a position ID of the first device, wherein audio of a telephone call is transmitted via the first wireless technology, at least in part based on the device ID.

In a fourth implementation, a method includes receiving a device registration response via a first wireless technology, the device registration response including an address of a supervisor computer; transmitting a low-power response via a second wireless technology, the low-power response indicating a first device ID of the first device, wherein the second wireless technology uses less power than the first wireless technology; transmitting an operation authorization via the first wireless technology, the operation authorization indicating the first device ID and the address of the supervisor computer; receiving an action input on an action key of the first device; and transmitting a position request via the first wireless technology, the position request including an indication of the action input and an indication of the first device ID.

In a fifth implementation, an apparatus includes a shaft extending in an axial direction thereof; a U-shaped member at a distal end of the shaft, the U-shaped member constructed to hold a telephonic handset; a switchhook button configured to disconnect a connection of the telephonic handset; and a base at a proximal end of the shaft.

### BRIEF DESCRIPTION OF THE SEVERAL VIEWS OF THE DRAWINGS

FIG. 1 illustrates an example of a PSAP, according to an implementation of the present disclosure.

FIG. 2 illustrates an external view of an electronic device, according to an implementation of the present disclosure.

FIG. 3 illustrates a logical view of an electronic device, according to an implementation of the present disclosure.

FIG. 4 illustrates a signal-flow algorithm for pairing an electronic device to a calltaker position via a computer of a supervisor, according to an implementation of the present disclosure.

FIG. 5 illustrates a signal-flow algorithm for pairing an electronic device to a calltaker position, according to an implementation of the present disclosure.

FIG. 6 illustrates a signal-flow algorithm for authorizing a computer of a supervisor to interact with a computer of a calltaker, according to an implementation of the present disclosure.

FIGS. 7A and 7B illustrate a signal-flow algorithm for pairing an electronic device to a calltaker position via a low-power wireless communication, according to an implementation of the present disclosure.

FIGS. 8A, 8B, 8C, 8D, 8E, 8F, 8G, 8H, 8I, and 8J illustrate a telephone cradle, according to an implementation of the present disclosure.

FIG. 9 illustrates a computing device, according to an implementation of the present disclosure.

### DETAILED DESCRIPTION

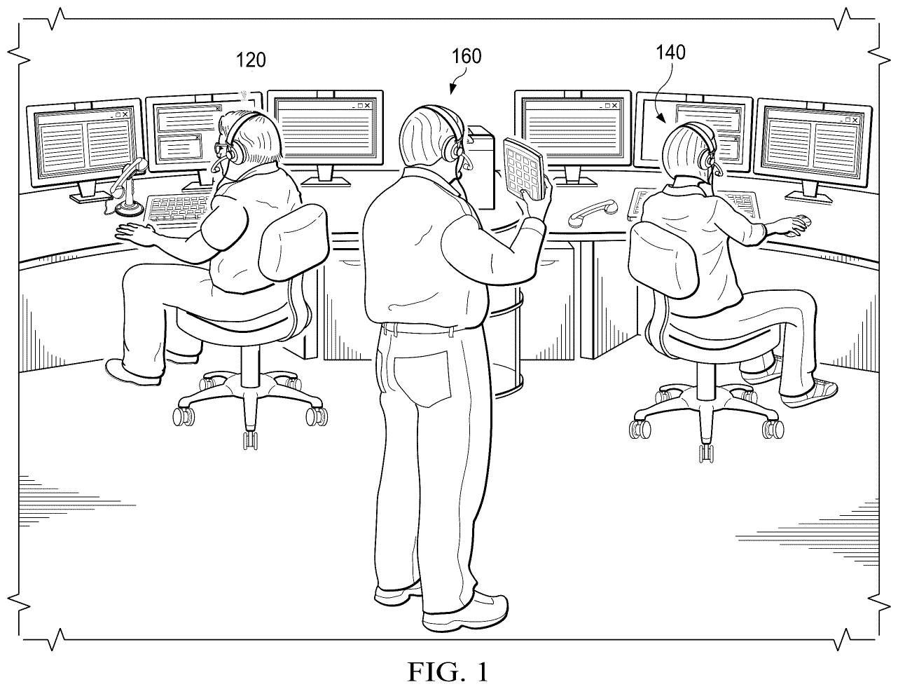

FIG. 1 illustrates an example of a PSAP, according to an implementation of the present disclosure. The illustrated PSAP includes a plurality of positions 120, 140. Each position 120, 140 is a workspace for a different calltaker. In the illustrated implementation, each workspace includes a separate computer, a separate telephone, and three monitors. In other implementations, there can be more or fewer calltakers, and the calltakers can share a computer and have more or fewer monitors.

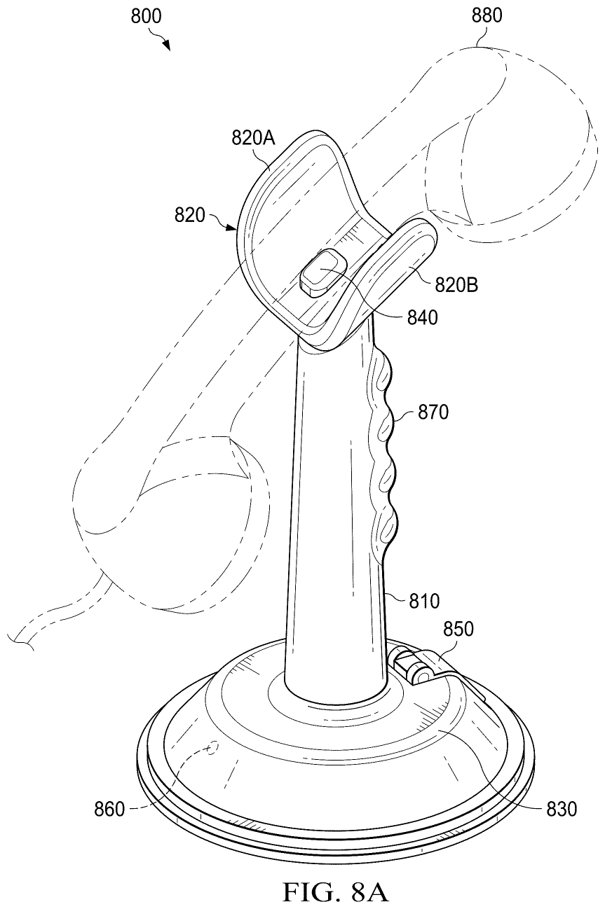

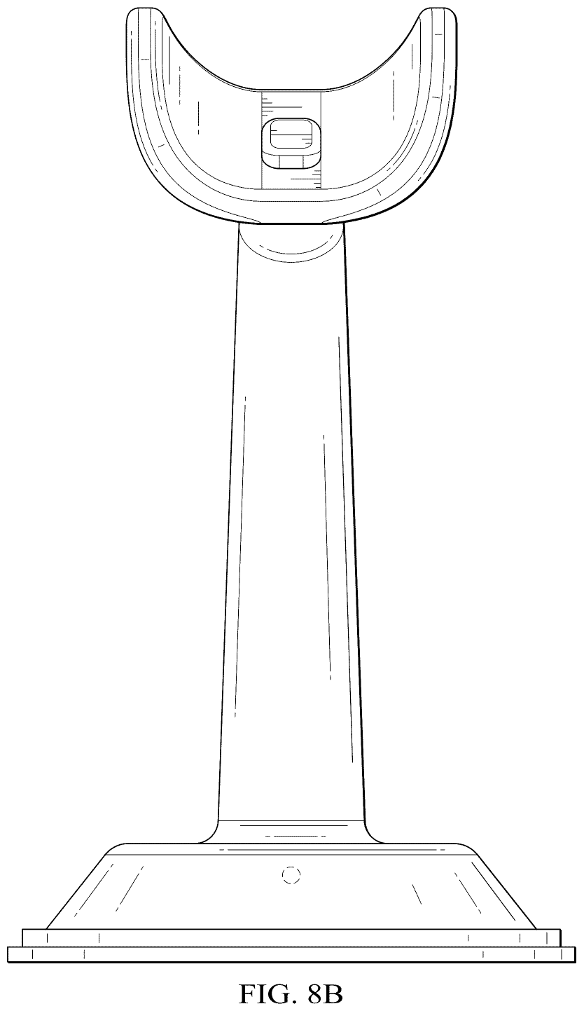

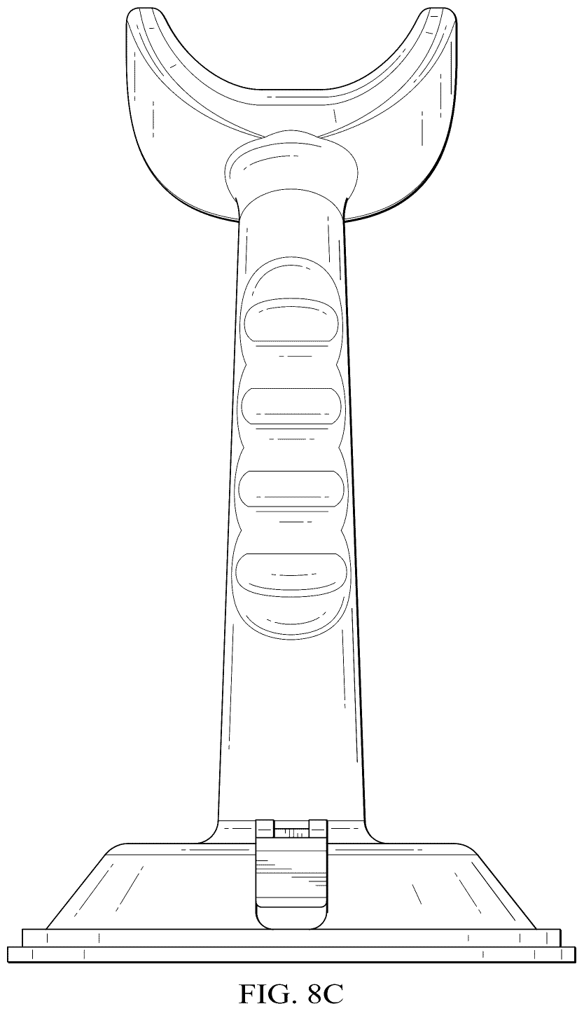

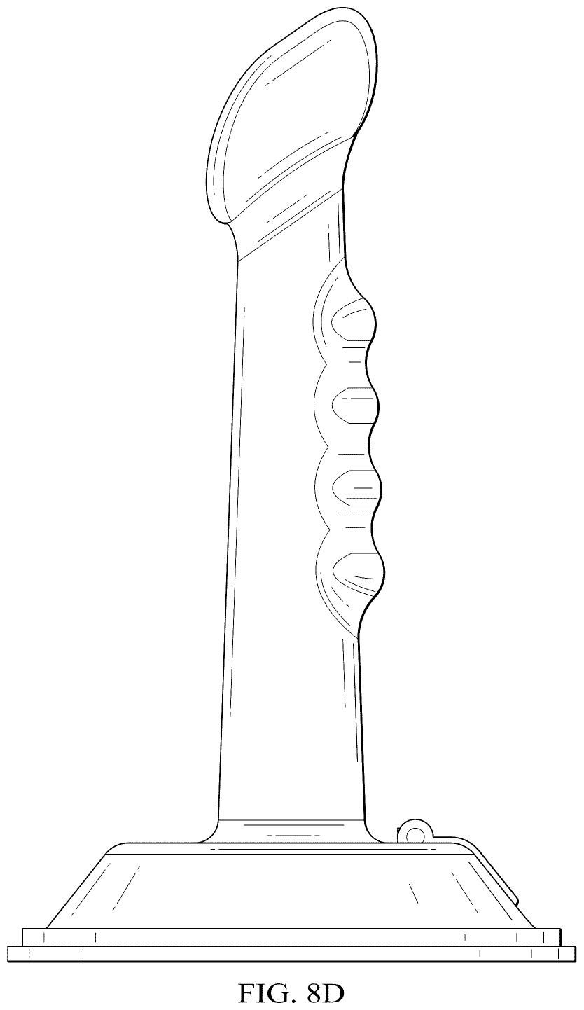

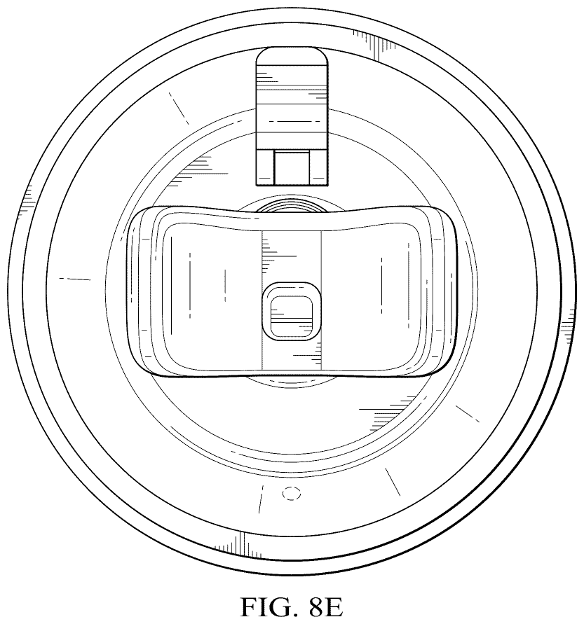

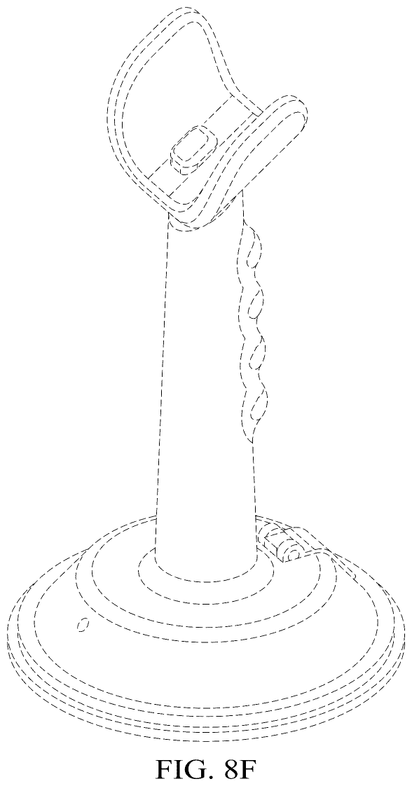

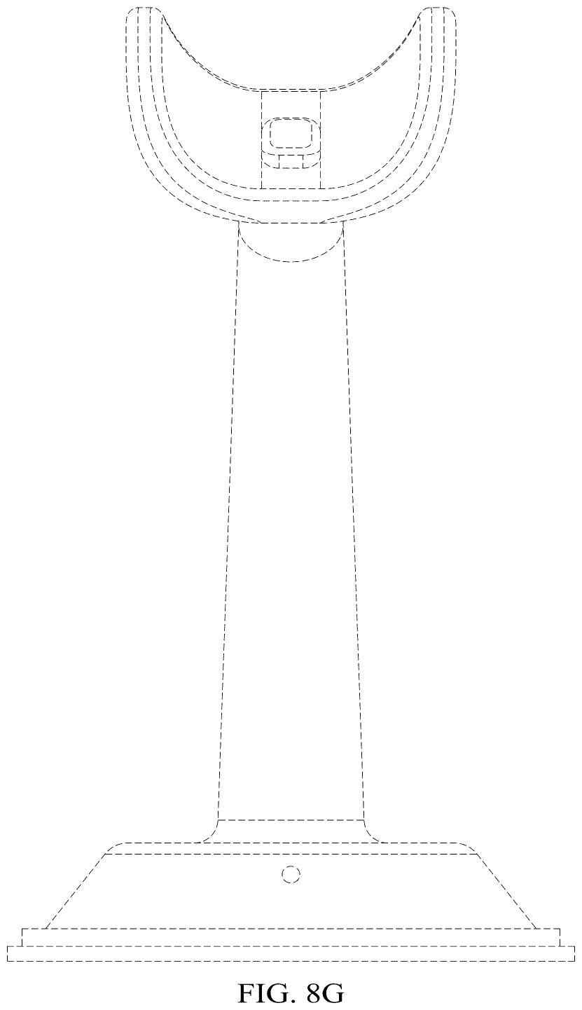

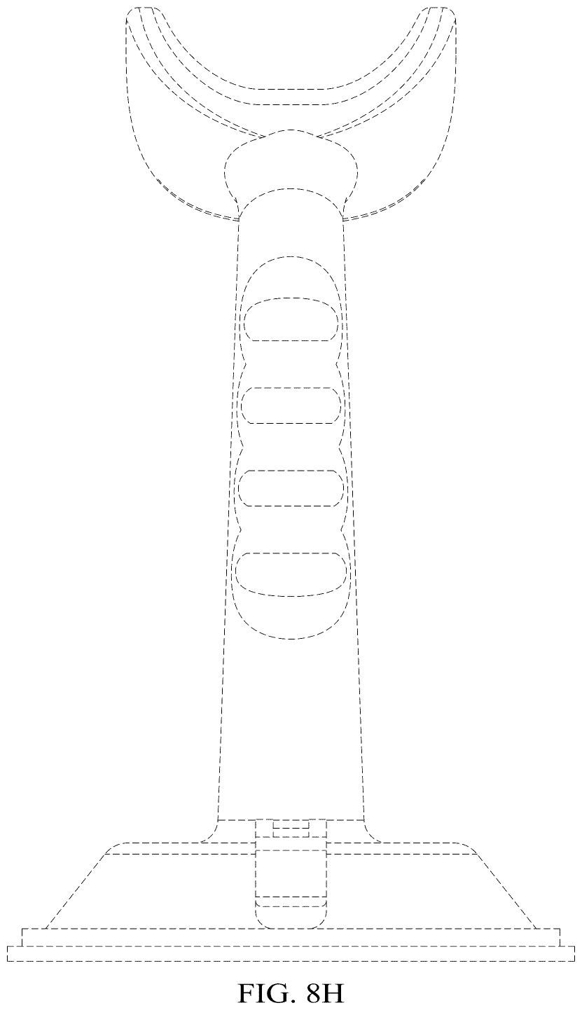

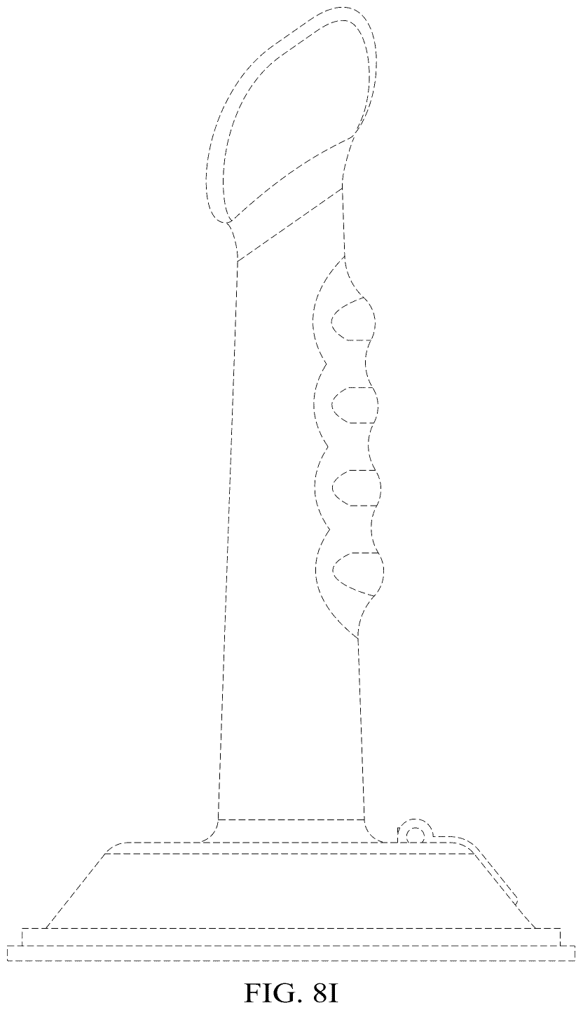

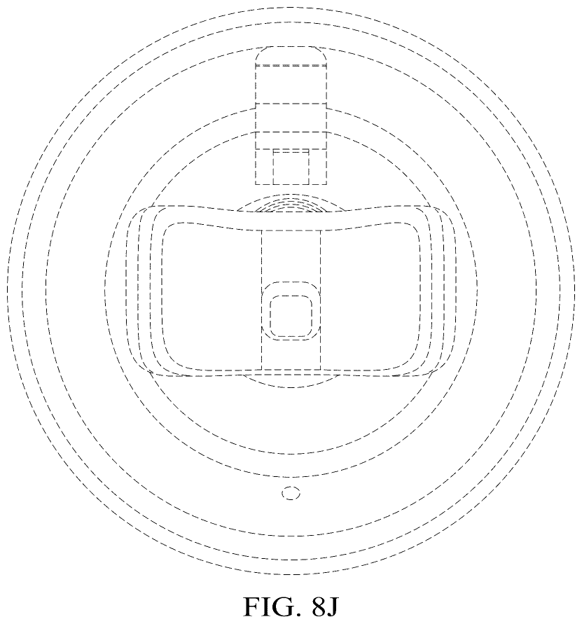

In FIG. 1, the position 120 includes a telephone handset supported by a telephone cradle, as discussed later in connection with FIGS. 8A-8J. In contrast, the position 140 does not include a telephone cradle for its telephone handset. Thus, the telephone handset at position 140 is likely to fall off the desk.

In the illustrated implementation, each calltaker is wearing a headset including headphones and a microphone. In some implementations, the headset does not include a microphone.

Each position 120, 140 can be identified by a position ID, such as in a sign displayed at the position. In various implementations, the position ID can be embedded in a near-field communication (NFC) chip at the position, in a memory of an NFC transmitter at the position, or in a displayed QR code, for example.

The illustrated PSAP also includes a supervisor 160. In FIG. 1, the supervisor 160 is standing and can walk around to positions 120, 140. Thus, the supervisor can supervise the calltakers in positions 120, 140, such as by watching the monitors and/or communicating with the respective calltaker.

As discussed previously, the supervisor 160 can sometimes take emergency and/or administrative calls. However, because the supervisor is not at their own position, they do not have access to an input device, such as a keyboard, to interact with a call. Therefore, a supervisor lacks functionality with respect to a call handled while not at their position. Accordingly, it can be difficult for the supervisor to listen to or join a telephone call at positions 120, 140.

A “call” (synonymous with the term “telephone call”) includes any exchange originating from one point and received by another point using a telephone system. The call can be carried by any type of medium, such as wired, wireless, satellite, infrared, Bluetooth™, Virtual Private Network (VPN), a proprietary link, etc. Further, this call can be between devices, between devices and communication platforms, between one or more proprietary devices, and/or between one more elements that leverage artificial intelligence (AI) and/or are powered by machine learning (ML). Further, any type of proxy can be implicated in such call scenarios (i.e., a call made on behalf of a device, a system, etc.).

The call can relate to an emergency or not relate to an emergency. The call can be made using the Plain Old Telephone Service (POTS) or using a more modern system, such as cellular telephones. The call can originate from a human or a computer. The call can originate from an Internet of Things (IoT) device. The call can be made using any computer network, such as the Internet. The call can arrive via any wire, fiber, wireless, or other transmission medium. The call can use IP telephony, such as Voice over Internet Protocol (VOIP). The call can arrive via a mobile phone app, such as Facebook Messenger, WhatsApp, LINE, Signal, or Telegram.

To potentially address this issue and others, various implementations of the present disclosure can implement telephony devices, as shown herein.

For example, some implementations of the present disclosure relate to an electronic device, herein referred to as a “Super Sidekick.” In select implementations, the Super Sidekick is a wireless device that is portable, lightweight, and easy to use. In many implementations, the Super Sidekick gives a supervisor the ability to remotely manage calls, while walking around supervising a dispatch floor of the PSAP.

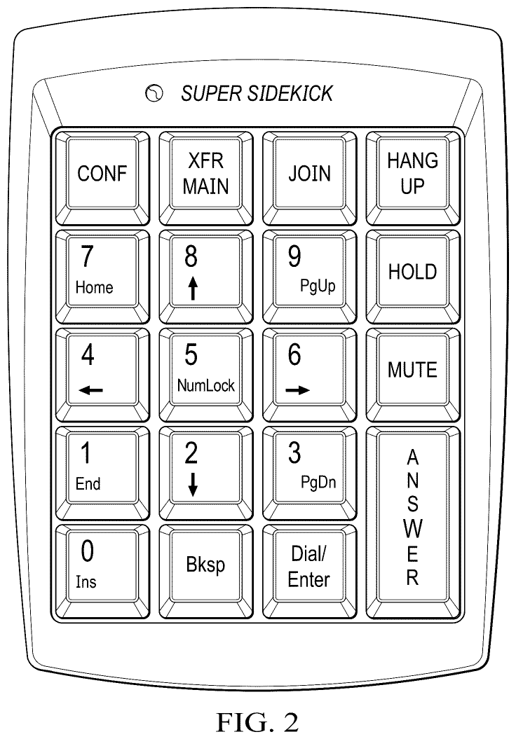

FIG. 2 illustrates an external view of an electronic device, such as the Super Sidekick, according to an implementation of the present disclosure.

As shown in FIG. 2, the Super Sidekick includes a 10-key numeric pad. The Super Sidekick also includes action keys. In several implementations, the action keys relate to function keys.

The 10-key numeric pad includes the numbers 0-9. As illustrated in FIG. 2, the 10-key numeric pad is ordered with the number “1” in the lower-left corner and the number “9” in the left column. Further, the number “0” is located below the number “1” and is left-justified. In this regard, the numeric pad is similar to that of some computer keyboards. Of course, other implementations are possible. For example, the numbers can be ordered with the number “1” in the upper-left corner and the number “9” in the lower-right corner. In such an implementation, the number “o” can be located in the center, below the number “8.” In such an implementation, the numeric pad is similar to a telephone keypad.

In a variety of implementations, the numeric pad can be used to produce dual-tone multi-frequency (DTMF) (“touch-tone”) signals. Thus, the numeric pad can dial telephone numbers or navigate automated menus, for example.

Thus, the generic term “pad” enables various types of interactions between users, between devices, and/or between one or more systems. In addition to the examples provided herein, a pad can include any suitable input device or input mechanism such as a microphone for speech, a touch-sensitive screen for gesture, tactile, or graphical input, a keyboard, a trackpad, a mouse, motion sensitive input, speech commands, etc. In some instances, multimodal systems can enable a user or a device to provide multiple types of input/output to communicate with other users, devices, and systems.

Because the Super Sidekick can pair to a computer, the computer can be programmed to accept inputs from keys of the numeric pad. Thus, in several implementations, the Super Sidekick keys can generate arrow commands. In the implementation illustrated in FIG. 2, the number “8” can perform the function of the “up” arrow, the number “4” can perform the number of the “left” arrow, the number “6” can perform the function of the “right” arrow, and the number “2” can perform the function of the “down” arrow. In implementations in which the numeric paid is similar to a telephone keypad, the “up” arrow can be associated with the number 2, and the “down” arrow can be associated with the number 8.

Other implementations are possible, such as to account for the Super Sidekick being worn below the waist over the supervisor. In at least one such implementation, the locations of the “up” and “down” arrows are reversed, and the location of the “left” and “right” arrows are reversed relative to a typical layout. In such an implementation, the supervisor can feel a more intuitive sense of extending for the “up” arrow and retracting for the “down” arrow, despite the relative positions of the “up” arrow being closer than the “down” arrow to the floor on which the supervisor is standing.

FIG. 2 shows an implementation in which the action keys are labeled CONF, XFR MAIN, JOIN, HANG UP, HOLD, MUTE, ANSWER, DIAL/Enter, and Bksp.

The CONF key allows the supervisor to initiate a conference call. For example, the supervisor can add an additional party, such as an emergency agency, to a call. In some implementations, when the supervisor activates the CONF key while on an existing call, a new telephone line is opened, and the supervisor can dial a telephone number using the numeric pad of the Super Sidekick. In many implementations, if the supervisor activates the CONF key again, the party called on the new telephone line (e.g., the emergency agency) is added to the existing call.

The XFR MAIN key allows a supervisor to call or create a conference to the main (e.g., non-emergency) number of the PSAP to transfer a call thereto. For example, a caller might be distraught about a cat stuck up a tree. Thus, a supervisor might determine the call merits a dispatch of personnel, but not necessarily in an emergency context. Accordingly, the supervisor can activate the XFR MAIN key to connect the call to a non-emergency line.

The supervisor can explain the situation to the calltaker, before activating the XFR MAIN key a second time to transfer of the call to the main number. Thus, the line to which the Super Sidekick is paired can receive another call.

The JOIN key allows a supervisor to listen to and/or join a call. In many implementations, if the Super Sidekick is paired to a position, then activation of the JOIN key allows the supervisor to participate in the call at that position.

In some implementations, a first activation of the JOIN key enables the supervisor to listen to a call, but the supervisor's microphone will be muted. Then, a second activation of the JOIN key while on the call can unmute the supervisor's microphone.

In other implementations, a first activation of the JOIN key enables the supervisor to join the call with the supervisor's microphone being active. If the supervisor wants to only listen to the call, then the MUTE key can be activated.

If the supervisor is on a call via the JOIN key and the original calltaker hangs up the call, then the hang-up can release the supervisor from the call as well.

Activation of the HANG UP key releases an ongoing call. For example, activating the HANG UP key can place an associated telephone line in the on-hook condition and disconnect an active call on that line.

Activation of the HANG UP key can release a call that the supervisor has answered or initiated. In some implementations, activation of the HANG UP key does not release a call to which the supervisor has listened or joined.

Activation of the HOLD key can put a call on hold so as to temporarily free a telephone line. For example, if the supervisor is on a non-emergency call when the number of emergency calls increases, the supervisor can place the non-emergency call on hold. Thus, the supervisor can answer an emergency call and later return to the non-emergency call.

After placing a call on hold, activating the HOLD key a second time can remove the call from the hold. Thus, the supervisor can again speak and listen to the caller. In select implementations, the HOLD key is activated for as long as the key is physically held and deactivates upon release of the key. In some implementations, the action keys can include an additional REMOVE HOLD key to deactivate the hold function.

The MUTE key can prevent a caller from hearing sound received by the supervisor's microphone. For example, a supervisor might want to discuss a strategy for handling a call with a calltaker during the call. In this case, it might be undesirable for the caller to hear the supervisor's discussion. Accordingly, the supervisor can activate the MUTE key to mute the supervisor's microphone. In this case, it is possible to avoid the caller overhearing the strategy discussion.

After muting the supervisor's microphone, activating the MUTE key a second time can unmute the supervisor's microphone. Accordingly, the caller can again hear sound received by the supervisor's microphone. In select implementations, the MUTE key can be activated for as long as it is physically held and deactivated upon release of the key. In some implementations, the action keys can include an additional UNMUTE key to deactivate the mute function.

Activation of the ANSWER key can pick up the next call in a call queue of the PSAP by priority. In some implementations, the priority is defined by the chronological receipt of the calls. In other implementations, the priority can be defined at least partially by the number dialed by the caller (e.g., emergency or non-emergency). In select implementations, the caller can provide a vocal or DTMF input responsive to a prompt or menu, and the priority is defined by the input. Other implementations are possible.

Activation of the DIAL/Enter key can join an open line from which the supervisor can dial a telephone number and/or transmit a dialed telephone number. The DIAL/Enter key can also be mapped to confirm actions in some implementations. For example, when the Super Sidekick is paired to a computer, pressing the DIAL/Enter key can provide an instruction similar to the Enter key on a numeric pad of a computer. In some implementations, activation of the DIAL/Enter key is similar to activation of a carriage return key on a computer keyboard.

Activation of the Bksp (“Backspace”) key can delete a last-entered digit. The Bksp key can also have functionality similar to a backspace key on a computer keyboard. Thus, the supervisor 160 can correct a mistake made while typing a telephone number, for example.

Thus, the action keys can provide functionality when the supervisor is operating independently of their position. In at least one implementation, the action keys map to computer function keys. For example, ANSWER can map to F1, MUTE can map to F2, XFR MAIN can map to F3, JOIN can map to F4, CONF can map to F5, HOLD can map to F6, and HANG UP can map to F8. Needless to say, other implementations are possible. Indeed, the computer can be programmed to map the action keys to any function keys.

In FIG. 2, the number “7” key is also mapped to a Home function. Activating this key can have a context-specific result. For example, activating the key can return a cursor to the beginning of a call record of an associated computer, line of text, or text box, for example.

Further, FIG. 2 shows the number “9” key mapped to the PgUp function and the number “3” key mapped to the PgDn function. Activating these keys also can have a context-specific result. For example, these keys can be used to scroll up or down within a call record by a screen view or by an emulated physical page of the call record on the visual display 340 or an associated computer.

As shown in FIG. 2, the number “1” key can be mapped to the End key. Again, activating this key can have a context-specific result. For example, activation of the End key can move a cursor to an end of a line of a call record or text box or can scroll to an end of a call record on the visual display 340 or an associated computer.

According to the implementation of FIG. 2, the number “o” key can be mapped to the Ins key. The Ins key can switch an input to a computer from the Super Sidekick between two modes. In the first, overwrite mode, a cursor of the computer can overwrite text in a current position of the cursor. In the second, insert mode, the cursor can insert a character at its current position, advancing characters beyond the cursor position by one position.

The implementation of FIG. 2 shows the number “5” key mapped to the Num Lock key. The Super Sidekick can recognize when the “5” button is held for a predetermined period of time, signaling the intention of the supervisor 160 to switch to a Num Lock state. In some implementations, a visual display of the Super Sidekick can display an indication of whether the Num Lock key is active. The Super Sidekick can switch the functionality of the number “5” key to the value “5,” if the “5” button is again held for a predetermined period of time.

As shown in FIG. 2, the Super Sidekick is illustrated with its keys in a particular location. In particular, FIG. 2 illustrates the action keys primarily along the top and right side of the pad. In various implementations, the action keys can be located in other locations. For example, the action keys can be located along the bottom and/or left side of the pad. The action keys can also be located offset from the numeric pad.

Further, in some implementations, the locations of the action keys can be modified for a more natural mapping to the function keys of a computer. For example, FIG. 2 illustrates HOLD, mapped to F6, adjacent to MUTE, mapped to F2. On the other hand, XFR MAIN, mapped to F3, is located at the sixth position, counting counterclockwise from ANSWER, mapped to F1. Thus, HOLD and XFR MAIN can be swapped, for a more natural mapping of the third key to F3. Further, such a mapping maps the sixth key to F6. Of course, other location modifications can be made.

Further, FIG. 2 illustrates the keys of the numeric pad as adjacent. In various implementations, the keys of the numeric pad can be exploded, such that there is a tactile space between the keys. Thus, the supervisor can better sense a relative position of their hand on the Super Sidekick, based on the tactile space. This sensing can be particularly useful when the supervisor is not looking at the Super Sidekick and is instead, for example, looking at a display at a position 120, 140.

Further, the top face of the keys of the Super Sidekick can include a boss. Thus, the supervisor can better sense the relative position of their hand, based on the boss. In many implementations, the boss is included on the number “0” key and/or the number “5” key. In some implementations, other textural features can be added to the keys. In select implementations, these textural features will arise from a recess.

Various implementations can omit one, some, or all of the action keys. Some implementations can add additional action keys, such as to park a call.

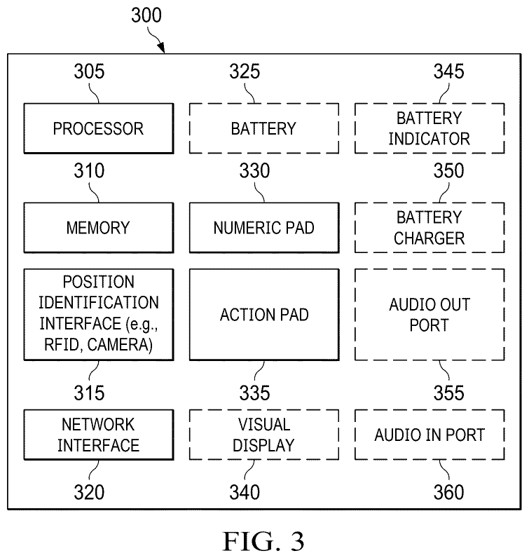

FIG. 3 illustrates a logical view of an electronic device, such as a Super Sidekick 300, according to an implementation of the present disclosure.

As shown in FIG. 3, the Super Sidekick 300 can include a processor 305, a memory 310, a position identification interface 315, a network interface 320, a battery 325, a numeric pad 330, and an action pad 335. In various implementations, the Super Sidekick 300 can include optional features, such as a visual display 340, a battery indicator 345, a battery charger 350, an audio out port 355, and an audio in port 360.

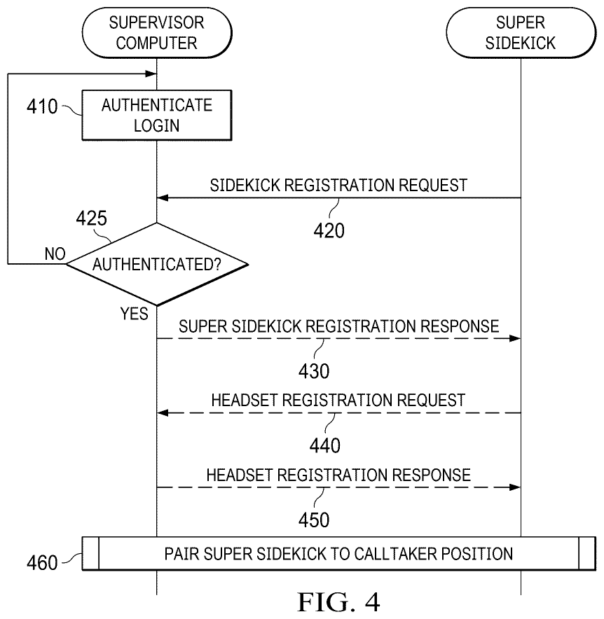

The processor 305 can perform information processing operations of the Super Sidekick 300. For example, the processor 305 can perform and/or coordinate operations discussed later in connection with FIGS. 4-5 and 7A-B. The processor 305 can execute an operating system such as Android, Windows, iOS, or iPadOS, for example.

The memory 310 can store variables and/or instructions for use by the processor 305. Although illustrated as one monolithic unit, the memory 310 can include a plurality of memories. In many embodiments, these memories can differ structurally. For example, the memory 310 can include both a solid-state drive and a dynamic random-access memory (DRAM). Several implementations of memory 310 can omit one or both of these memories and can include one or more additional memories.

The position identification interface 315 is an interface for identifying position 120, 140. In many implementations, the position identification interface 315 is a wireless interface, although implementations including a wired interface are within the scope of the present disclosure.

In various implementations, the position identification interface 315 can be or include a camera. In many implementations, the position identification interface 315 can be or include a Radio-frequency identification (RFID) transceiver and/or transponder that uses a wireless technology, such as Bluetooth and/or Near-Field Communication.

The network interface 320 can transmit data to and/or receive data from a computer, such as a computer of the supervisor or a computer at position 120, 140. In many implementations, the network interface 320 is a wireless interface, although implementing the network interface 320 as a wired interface is within the scope of the present disclosure. Examples of a wireless interface include Bluetooth, WiFi, Zigbee, LTE (4G), 5G, and/or 6G. The network interface 320 can be used to perform operations discussed later in the context of FIGS. 4-5 and 7.

The optional battery 325 supplies power to the Super Sidekick 300. The battery 325 can be single-use or rechargeable. An exemplary single-use battery is an alkaline battery. An exemplary rechargeable battery is a lithium-ion battery. The battery 325 can include one or more batteries, and these batteries can be different types.

The numeric pad 330 can be or include the numeric pad discussed in connection with FIG. 2. The keys of the numeric pad can be hard or soft. In the case of hard keys, the keys can be optical switches, Hall Effect switches, or other mechanical switches. If the Super Sidekick 300 includes the visual display 340, the numeric keys can be displayed as soft keys.

The action pad 335 can be or include the action keys discussed in connection with FIG. 2. Like the numeric pad 330, the keys of the action pad 335 can be hard or soft. In the case of hard keys, the action keys can be optical switches, Hall Effect switches, or other mechanical switches. The action pad 335 can be a different type of switch from the numeric pad 330. If the Super Sidekick 300 includes the visual display 340, the action keys can be displayed as soft keys.

The optional visual display 340 is a screen, for example. In particular, in many implementations, the visual display 340 can be a liquid crystal display (LCD) and/or light-emitting diode (LED) panel. The visual display 340 can display a graphical user interface produced by a computer, such as the supervisor's computer. In several implementations, when the Super Sidekick 300 pairs with a position 120, 140, the visual display 340 displays one or more screens or windows of the computer at the position 120, 140. In some implementations, the Super Sidekick 300 can generate a graphical user interface, independent of the supervisor's computer and computers at the positions 120, 140. In select implementations, the graphical user interface can include the numeric pad 330 and/or the action pad 335. Further, the visual display 340 can display a telephone number being dialed, a telephone number of a current connection, and/or a status of an ongoing call.

The optional battery indicator 345 can indicate an amount of charge remaining in the battery 325. The battery indicator 345 can indicate this amount via a visual, audio, or haptic indication. In some implementations, the battery indicator 345 can indicate this amount by transmitting information to the supervisor's or calltaker's computer, for example. In some implementations, the visual display 340 can display the battery indicator 345.

In implementations including the optional battery charger 350, the battery charger 350 can charge the battery 325. The battery charger 350 can be or include a wired interface that can connect to a power outlet. The battery charger 350 generally does not include an alternating current (AC) to direct current (DC) converter, as the converter can increase the weight and size of the Super Sidekick 300. However, such implementations are possible. In some implementations, the battery charger 350 can be a wireless interface, such as for inductive charging.

The optional audio out port 355 can be a phone connector that provides a wired interface to output an audio signal via headphones and/or speakers, for example. In various implementations, the audio out port 355 is or includes a headphone jack.

Some implementations without the audio out port 355 can output an audio signal via the network interface 320. For example, the network interface 320 can output an audio signal via a Universal Serial Bus Type-C (USB-C) or Bluetooth (e.g., IEEE (Institute of Electrical and Electronics Engineers) 802.15.1).

The optional audio in port 360 can be a phone connector that accepts an audio input from a microphone, for example. The microphone can be included in a headset to be worn by the supervisor, for example. In some implementations, the audio in port 360 can be combined with the audio out port 355.

Some implementations without the audio out port 355 can receive an input from the network interface 320. For example, the Super Sidekick 300 can receive an audio signal via USB-C or Bluetooth (e.g., from a Bluetooth-compatible headset).

In many implementations, the Super Sidekick 300 can include additional features, such as a volume control knob.

FIG. 4 illustrates a signal-flow algorithm for pairing an electronic device to a calltaker position via a computer of a supervisor, according to an implementation of the present disclosure.

The signal flow begins at 410 at which the supervisor computer authenticates a login of the supervisor. The supervisor's computer can authenticate the login in any manner, such as a login and password, a biometric authentication, and/or a multifactor authentication. In this way, the supervisor computer can prevent an unauthorized pairing of the Super Sidekick. In addition, when the supervisor computer acts on behalf of the Super Sidekick, the actions can be attributed to a particular user (i.e., the authenticated supervisor). The signal flow then advances to 420.

In 420, the Super Sidekick transmits a sidekick registration request that is received by the supervisor computer. The Super Sidekick can transmit the sidekick registration request by a broadcast, for example. In some implementations, the Super Sidekick can transmit the sidekick registration request in the form of a Bluetooth discoverable mode transmission. The sidekick registration request can indicate or include a device ID, a device address, a device name, and/or a device profile of the Super Sidekick. The signal flow then advances to 425.

In 425, the supervisor computer can determine whether the login is still authenticated. For example, the supervisor computer can determine whether the login authenticated at 410 is still authenticated at the time the sidekick registration request is received at 420. Thus, some implementations can avoid an issue in which a personnel shift change has occurred between authentication and sidekick registration, and the Super Sidekick is improperly registered to a previous supervisor.

If the supervisor computer determines the login is not still authenticated, the signal flow returns to 410. If the supervisor computer determines the login still is authenticated, then the supervisor computer stores the login in association with, e.g., the device ID of the Super Sidekick, and the signal flow then advances to 430.

The supervisor computer can optionally transmit a sidekick registration response in 430 that is received by the Super Sidekick. In some implementations, the sidekick registration response is an acknowledgement. In other implementations, the sidekick registration response can include a device ID, a device address, a device name, and/or a device profile of the supervisor computer.

The signal flow then advances to optional 440.

In 440, the Super Sidekick can optionally transmit a headset registration request that is received by the supervisor computer. In some implementations, a supervisor intends to use a wireless headset with the Super Sidekick. Configuring the wireless headset for use with the Super Sidekick might be cumbersome, if the wireless headset and the Super Sidekick do not interact with each other. Thus, in various implementations, the headset registration request includes or indicates a device ID of the Super Sidekick and a device ID of the wireless headset. In this way, the supervisor computer can determine that inputs it receives from the Super Sidekick relate to the call whose audio is being sent to the wireless headphones.

In specific implementations, the headphone registration request can additionally or alternatively include or identify a device address, a device name, and/or a device profile of the wireless headset. In some implementations, the Super Sidekick can receive the device ID of the wireless headset via the numeric pad. In several implementations, the Super Sidekick can receive the device ID, the device address, the device name, and/or the device profile from the wireless headphones while initiating a wireless connection. For example, such information can be received during initiation of a Bluetooth session between the Super Sidekick and the wireless headset.

The signal flow then advances to 450.

In 450, the supervisor computer optionally transmits a headset registration response. The headset registration response can be an acknowledgement, for example.

In select implementations, the Super Sidekick can play an audio tone upon receipt of the headset registration response. In this way, the supervisor can know that any silence in the headset relates to silence on the call, rather than an insufficient pairing between the Super Sidekick and the supervisor computer.

The signal flow then advances to 460.

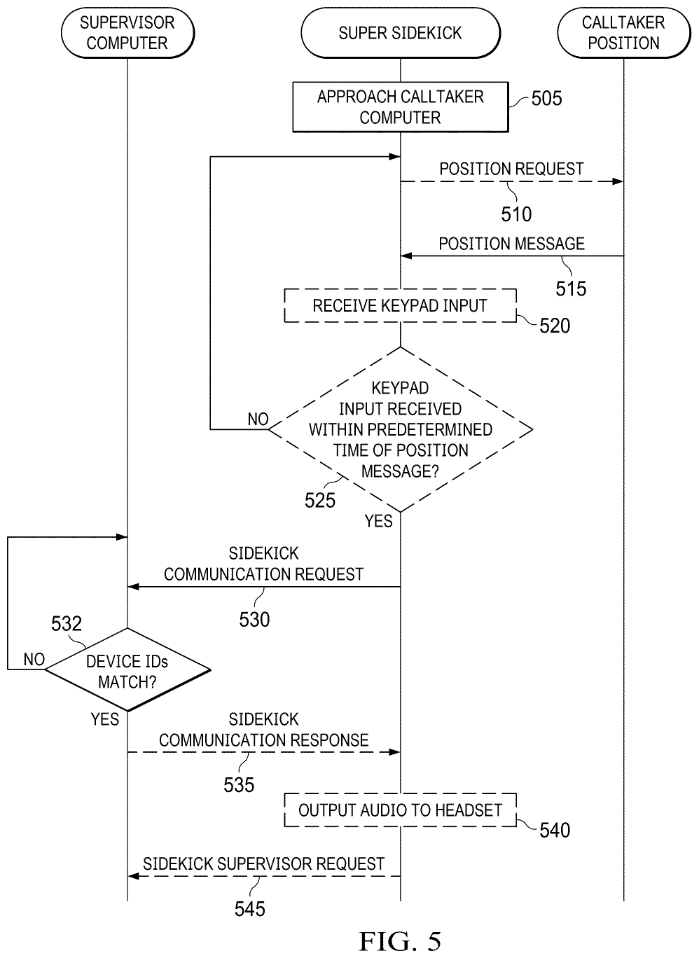

In 460, the Super Sidekick can wirelessly pair to a calltaker position as discussed in more detail in connection with FIG. 5.

FIG. 5 illustrates signal-flow algorithm for pairing an electronic device to a calltaker position, according to an implementation of the present disclosure.

The signal flow begins at 505 in which the supervisor approaches a calltaker position. By virtue of being worn, held, or similar by the supervisor, the Super Sidekick also approaches the calltaker position. The signal flow then advances to 510.

In 510, the Super Sidekick optionally transmits a position request.

In some implementations, the position request is transmitted by near-field communication. In such an implementation, the Super Sidekick can simply be brought into contact with (e.g., tapped against) an NFC tag located at the position. The signal flow then advances to 515.

In 515, the Super Sidekick receives a position message via the position identification interface. The position message can include a position ID of the position 120, 140.

In many implementations, the position ID is a number, such as “2.” In some implementations, the position ID can be a unique identifier within a jurisdiction (e.g., a county or state) to identify a particular calltaker's position. Indeed, the position ID can identify a calltaker's shift or the calltaker themself. The position ID can be alphanumeric, particularly in implementations in which the Super Sidekick includes an alphanumeric pad. The generic term “position ID” encompasses any type of distinguishing characteristic (geographic vs. non-geographic, hierarchical vs. arbitrary assignment, structured ordering based on a timing protocol, proprietary characteristic for a state, county, zip code, etc., or proprietary to a protocol, or to a specific company or agency, or to a specific technology, etc.) to be used in the activities discussed herein. Hence, this position ID can be associated with virtually any type of numeric, alphabetic, alphanumeric, symbol, logo, badge, image, or graphic identifier, or any suitable combination thereof that identifies or otherwise represents its corresponding element.

In some implementations, the position message is received via the same technology by which the position request was transmitted. Thus, for example, the Super Sidekick can receive the position in an NFC communication.

In some implementations, a physical object at the position can display the position ID as a QR code. The physical object can be a sticker, a plastic plate, or the like. In such an implementation, the position identification interface of the Super Sidekick can be a camera and can capture an image of the QR code. The processor 305 can process the QR code to determine the position ID.

In other implementations, the physical object can display a numeric identifier and/or include an NFC tag or Bluetooth transmitter or receiver. In some implementations, the calltaker computer can be enhanced to display the QR code on a display.

In various implementations, NFC can be particularly advantageous. NFC is a low-power method of communication and thus is suitable for battery-powered devices, such as the Super Sidekick is in many implementations.

In many implementations, the Super Sidekick can receive an entry of a position on the numeric pad from the supervisor. For example, the supervisor can activate the JOIN key and then type in the number of the position on the pad. In some such implementations, the Super Sidekick outputs audio (e.g., a tone or voice prompt) to the audio out, so that the supervisor is aware of the Super Sidekick's mode of operation. Thus, the supervisor can be alerted that, although the Super Sidekick is accepting input, the supervisor is not dialing to an active phone line.

In many implementations, the Super Sidekick begins a timer upon receipt of the position message.

The signal flow then advances to 520.

In 520, the Super Sidekick can optionally receive an input on one of the pads. For example, the Super Sidekick can receive an activation of the JOIN key. The signal flow then advances to 525.

In 525, the Super Sidekick can optionally perform a determination whether the pad input was received within a predetermined time of receiving the position message at 515. In some implementations, this determination can be based on comparing a timer begun upon receipt of the position message against a predetermined period.

If the Super Sidekick determines the pad input is not received within the predetermined period, the signal flow returns to optional 510. If the Super Sidekick determines the pad input is received within the predetermined period, then the signal flow advances to 530.

Thus, in some implementations, the determination at 525 can be advantageous, as it serves as a check on the intention of the supervisor. For example, a supervisor might place their Super Sidekick down, after walking to a position, and inadvertently set the Super Sidekick on an NFC tag. Alternatively, the supervisor might take a picture using the Super Sidekick (e.g., if the Super Sidekick is implemented using a tablet computer), and the picture might inadvertently include the QR code of a position. Thus, a situation, in which the Super Sidekick interprets an inadvertent receipt of a position message as an input, can be avoided.

In 530, the Super Sidekick transmits a device communication request to the supervisor computer. The device communication request can indicate the device ID of the Super Sidekick and the position ID. In select implementations, the device communication request can indicate the pad input.

In many implementations, the device communication request can be transmitted via a longer-range wireless connection, such as Bluetooth, WiFi, Zigbee, 4G, 5G, or 6G. Because the Super Sidekick might be at a position, rather than near the supervisor computer, a shorter range wireless connection, such as NFC, might be insufficient for communication between the Super Sidekick and the supervisor computer.

Thus, the supervisor computer can determine to output the audio of the call at the position identified by the position ID to the Super Sidekick device identified by the device ID of the Super Sidekick.

In an implementation in which the device communication request indicates the pad input, the supervisor computer can determine an operation to be performed by the Super Sidekick device identified by the device ID, relative to the position identified by the position ID. For example, if the pad input indicates the JOIN key, then the supervisor computer can join the Super Sidekick device to the call at the position identified by the position ID.

The signal flow then advances to 532.

In 532, the supervisor computer can determine whether a device ID indicated in the registration request matches the device ID indicated in the device communication request. If the supervisor computer determines the device IDs do not match, then the communication response can indicate an error signal and return to 530. If the supervisor computer determines the device IDs match, the signal flow advances to 535.

In 535, the supervisor computer transmits a communication response received by the Super Sidekick. In various implementations, the communication response can be or indicate an acknowledgement of the communication request. In many implementations, the communication response includes an audio signal, such as the audio of the call at the position.

In many implementations, the supervisor computer transmits the communication response, at least in part based on a determination that the login was still authenticated in 425. Thus, the supervisor computer can avoid transmitting the audio of the telephone call, unless a supervisor has successfully logged into the supervisor computer.

In implementations in which Super Sidekick transmitted a headset registration request, the supervisor computer can transmit the communication response, based on the device ID of the wireless headset.

The signal flow then advances to 540.

In 540, the Super Sidekick can optionally output audio to headphones of the supervisor, such as via audio out port 355. In several implementations, the output audio is the audio of the call at the position. In some implementations, the output audio is an audio tone generated by the Super Sidekick or received in the communication response. In such an implementation, the Super Sidekick can indicate a pairing has occurred, even if the call at the position is currently silent or quiet.

In 545, the Super Sidekick can receive an input on a key of a pad, such as an action key on the action pad 330 or a numeric key on numeric pad 335. The Super Sidekick then wirelessly transmits a sidekick supervisor request to the supervisor computer via the first wireless connection. The sidekick supervisor request can include or indicate the input and a device ID of the Super Sidekick. The supervisor computer can then process the input as if the input had been input to the supervisor computer itself.

Thus, for example, if the input indicates the HANG UP key of the action pad has been activated, the supervisor computer can apply the function to disconnect the call. In another example, the Super Sidekick can receive a sequence of numeric inputs and transmit data identifying the sequence. The supervisor computer can then apply the numeric inputs and dial a telephone number identified by the sequence.

In some instances, the audio in port 360 can receive an audio input from a microphone in a headset of the supervisor, for example. In such an instance, the supervisor computer can receive the audio input and apply it to (e.g., enter it into) the call. Thus, the supervisor can speak or otherwise participate within the telephone call to which the supervisor is listening.

Thus, in use of one implementation, a supervisor logs into the supervisor computer at 410. The supervisor can use the Super Sidekick to send a registration request at 420, such as via a Bluetooth discoverable mode transmission. The supervisor computer can reply with a registration response, such that the Super Sidekick receives an address of the supervisor computer. The supervisor can pair a headset with the supervisor computer following a similar procedure. Of course, in other implementations, the headset can be paired using the address of the supervisor computer or via the Super Sidekick.

The supervisor can then walk around the PSAP and approach a calltaker position. The supervisor can identify a position of a calltaker, regardless of whether the calltaker is currently taking a call. The Super Sidekick can receive a position message identifying the position, such as by an NFC response, a photograph of a QR code, or the supervisor typing the position number on the numeric pad of the Super Sidekick.

To avoid an inadvertent pairing to a position, the Super Sidekick can ensure a pad confirmation is received within a predetermined period of the position message. If it is, then the Super Sidekick can transmit a sidekick communication request indicating the position number to the supervisor computer. If the Super Sidekick previously registered with the supervisor computer, then the supervisor computer can transmit a communication response, such as with the audio of a telephone call at the position. The Super Sidekick can output the audio to the headset of the supervisor. If the supervisor wishes to speak or enter data via the numeric or action pad, the Super Sidekick can transmit such data in a sidekick supervisor request for the supervisor computer to act accordingly.

Thus, the supervisor can take calls while also supervising a calltaker.

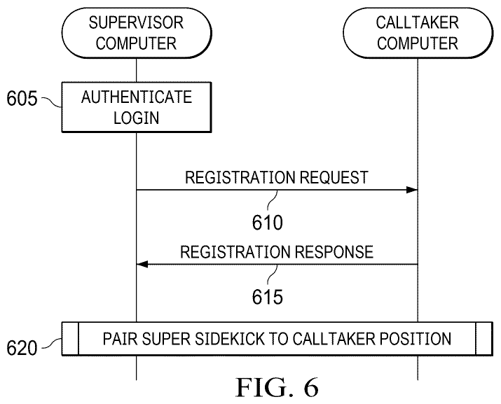

FIG. 6 illustrates a signal-flow algorithm for authorizing a computer of a supervisor to interact with a computer of a calltaker, according to an implementation of the present disclosure.

The signal flow begins at 605, in which the supervisor computer authenticates a login of the supervisor computer. This authentication is similar to that discussed in connection with 410. For example, the supervisor computer can authenticate the login by any means, such as a login and password, biometric authentication, and/or multifactor authentication. The signal flow then advances to 610.

In 610, the supervisor computer can transmit a registration request received by the calltaker computer. The registration request can include or otherwise indicate a supervisor ID associated with the login.

The signal flow then advances to 615.

In 615, the calltaker computer transmits a registration response received by the supervisor computer. The registration response can include or otherwise indicate a position ID. Thus, in a PSAP with a plurality of calltaker computers, the supervisor computer can associate the supervisor ID with the potential positions of the calltaker computers.

The signal flow then advances to 620.

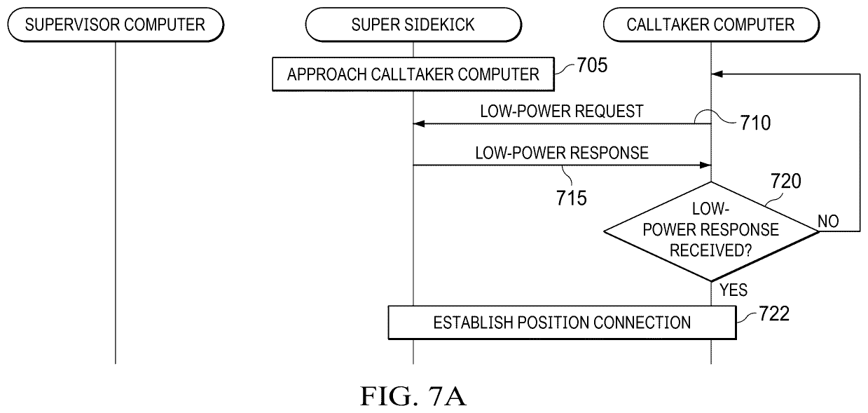

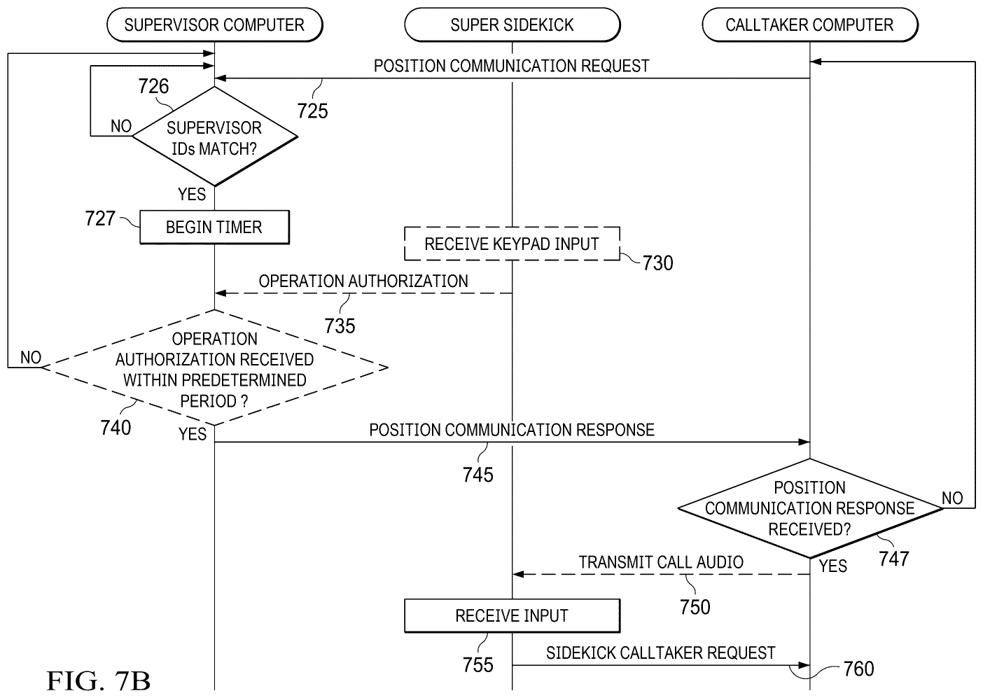

In 620, the Super Sidekick can wirelessly pair to a position of the calltaker computer as discussed in more detail in connection with FIG. 7.

FIGS. 7A-7B illustrate a signal-flow algorithm for pairing an electronic device to a calltaker position via a low-power wireless communication, according to an implementation of the present disclosure.

The signal flow begins at 705 in which the supervisor approaches a calltaker position. By virtue of being worn, held, or similar by the supervisor, the Super Sidekick approaches the calltaker position. The signal flow then advances to 710.

In 710, a low-power transmitter at the position wirelessly transmits a low-power request received by the Super Sidekick. In many implementations, the low-power request is transmitted by the calltaker computer.

The low-power request is transmitted by a low-power wireless technology, such as NFC. Such an implementation can be advantageous, because the Super Sidekick does not itself use its limited battery to transmit a signal that might not even be received.

In 715, the Super Sidekick can transmit a low-power response that is received by the calltaker computer. The low-power response can include the device ID of the Super Sidekick.

In implementations in which the position identification interface 315 is or includes an NFC unit, the low-power request activates the NFC unit (e.g., tag) in or on the Super Sidekick, and the NFC unit generates the low-power response.

The signal flow then advances to 720.

In 720, the calltaker computer determines whether the low-power response was received. If the calltaker computer determines the low-power response was not received, then the signal flow returns to 710. If the calltaker computer determines the low-power response was received, then the signal flow advances to 725.

In 725, the calltaker computer transmits a position communication request that is received by the supervisor computer. The position communication request can indicate the device ID of the Super Sidekick and a position ID of the calltaker computer. The position communication request can additionally indicate the supervisor ID received in 610 in the registration request.

Generally, the supervisor computer is outside the range of a low-power wireless technology, such as NFC. Thus, in several implementations, the calltaker computer transmits the position communication request via a longer-distance wireless technology than the low-power request. For example, the calltaker computer can transmit the position communication request via a Bluetooth or WiFi.

The signal flow then advances to 726.

In 726, the supervisor computer can determine whether the supervisor ID in the position communication request received at 725 matches the supervisor ID in the registration response received at 615. Thus, the supervisor computer can avoid a situation in which a supervisor who registered with the calltaker computer is not the supervisor who is attempting to join a call at the calltaker computer.

If the supervisor computer determines the supervisor IDs do not match, the signal flow returns to 725. If the supervisor computer determines the supervisor IDs do match, the signal flow then advances to 727.

In 727, the supervisor computer can begin a timer.

The signal flow then advances to 730.

In 730, the Super Sidekick can optionally receive a pad input. In at least one such implementation, the pad input is received via an action key, such as the JOIN key.

The signal flow then advances to 735.

In 735, if the Super Sidekick determines the pad input was received in 730, then the Super Sidekick can transmit an optional operation authorization received by the supervisor computer. The operation authorization can include the device ID of the Super Sidekick. The operation authorization can be sent via a longer-distance wireless technology such as WiFi or Bluetooth.

The signal flow then advances to 740.

In 740, the supervisor computer can optionally determine whether the operation authorization was received within a predetermined period from the communication request. For example, this determination can be based on comparing a time at which the operation authorization was received against the timer begun in 727. If the supervisor computer determines the operation authorization was not received within a predetermined period from the position communication request, then the operation authorization can be considered stale and the signal flow returns to 725. If the supervisor computer determines the operation authorization was received within the predetermined period from the position communication request, then the signal flow advances to 745.

Thus, in some implementations, the determination at 740 can be advantageous, as it serves as a check on the intention of the supervisor. For example, a supervisor might place their Super Sidekick down, after walking to a position, and inadvertently set the Super Sidekick on an NFC tag. Thus, a situation, in which the supervisor computer interprets an inadvertent receipt of a communication request as an input, can be avoided.

In 745, the supervisor computer transmits a position communication response that is received by the calltaker computer. The position communication response can be transmitted via the longer-distance wireless technology. The position communication response can indicate the position ID, for example. The signal flow then advances to 747.

In 747, the calltaker computer determines whether the position communication response was received in 745. If the calltaker computer determines the position communication response was not received in 745, then the signal flow returns to 725. If the calltaker computer determines the position communication response was received in 745, then the signal flow then advances to 750.

In 750, the calltaker computer can transmit audio of a telephone call at the position to the Super Sidekick. This transmission can be via a longer-distance wireless technology, and can be based at least in part on the device ID of the Super Sidekick. For example, this transmission can be via the position connection established in 722. In this way, the calltaker computer can specify which Super Sidekick is to receive the communication, in a situation in which there are multiple Super Sidekicks within the PSAP.

The communication can be via a wireless technology such as Bluetooth or WiFi. In many implementations, the communication is not via NFC, because of the low bandwidth of that technology.

The communication can include the audio signal of a telephone call being handled by the calltaker computer at the position.

In 755, the Super Sidekick can receive an input. For example, the Super Sidekick can receive an input on a key of a pad, such as an action key on the action pad 335 or a numeric key on the numeric pad 330.

The signal flow then advances to 760.

In 760, the Super Sidekick wirelessly transmits a sidekick position request to the calltaker computer via the longer-range wireless connection. The sidekick position request can include or indicate the input and the device ID of the Super Sidekick. The calltaker computer can then process the input as if the input had been input to the calltaker computer itself.

Thus, for example, if the input indicates the HANG UP key of the action pad has been activated, the calltaker computer can apply the function to disconnect the call. In another example, the Super Sidekick can receive in 755 a sequence of numeric inputs and transmit data identifying the sequence in 760. The calltaker computer can then apply the numeric inputs and dial a telephone number identified by the sequence.

In some instances, the audio in port 360 can receive an audio input from a microphone in a headset of the supervisor in 755, for example. In such an instance, the calltaker computer can receive the audio input in 760 and apply it to (e.g., enter it into) the call. Thus, the supervisor can speak or otherwise participate within the telephone call to which the supervisor is listening.

In some implementations, the communication can be two-way. Thus, inputs received at the Super Sidekick can be transmitted to the calltaker computer. In one example, the Super Sidekick can receive an input via the XFR MAIN function key. The Super Sidekick can then transmit a signal indicating the XFR MAIN input to the calltaker computer via the wireless communication. Accordingly, the calltaker computer can perform the transfer or request the supervisor computer to perform the transfer.

In some implementations, the NFC/QR identifiers can be located at the supervisor's desk. Thus, the supervisor can identify the position without walking to the position.

In FIG. 7B, the communication initiated at 750 was illustrated as performed by the calltaker computer. In some implementations, the supervisor computer can initiate this communication to the Super Sidekick.

Some operations or other aspects of FIGS. 7A-7B were discussed with regard to the calltaker computer. In select implementations, the position includes an additional device that can perform one, some, or all of these operations. Similarly, the additional device can have any or all such aspects. In some implementations, the additional device is a peripheral of the calltaker computer, for example.

In many implementations, the operations of FIGS. 4-7B are transmitted via a wireless connection, such as Wi-Fi or Bluetooth. In some implementations, these operations are transmitted via a wired interface.

In some implementations, the position request, position message, low-power request, and low-power response are advantageously performed using NFC. In comparison to NFC, Wi-Fi and Bluetooth are higher power and longer range communications.

Thus, in use of one implementation, a supervisor logs into the supervisor computer at 410. The supervisor can use the Super Sidekick to send a registration request at 420, such as via a Bluetooth discoverable mode transmission. The supervisor computer can reply with a registration response, such that the Super Sidekick receives an address of the supervisor computer. The supervisor can pair a headset with the supervisor computer following a similar procedure. Of course, in other implementations, the headset can be paired using the address of the supervisor computer or via the Super Sidekick.

Further, the supervisor computer can transmit a registration request at 610 to the calltaker computer. Thus, the calltaker computer can determine an authorization by a supervisor to permit pairing. The calltaker computer can return a registration response.

The supervisor can then walk around the PSAP and approach a calltaker position. The supervisor can tap the Super Sidekick to an NFC transmitter at the position of the calltaker. The NFC transmitter can transmit a low-power request, which the Super Sidekick can modulate to return a device ID. The calltaker computer can then establish a position connection to the Super Sidekick, such as a WiFi or Bluetooth connection, based on the information returned in the low-power request.

The calltaker computer can also transmit a position communication request to the supervisor computer. After confirming that the request is intended for the currently-authenticated supervisor, the supervisor computer can wait for an operation authorization from the Super Sidekick.

Meanwhile, the supervisor can activate an input (generally, a pad input, although voice inputs are also possible) on the Super Sidekick to transmit an operation authorization to the supervisor computer. Thus, the supervisor can confirm their intention to interact with a call at the position of the calltaker computer.

The supervisor computer confirms that the operation authorization was received within a predetermined period of the position communication request. Having done so, the supervisor computer transmits a position communication response to the calltaker computer. Having determined that the position communication response was received, the calltaker computer can transmit the audio of a telephone call at the position. The Super Sidekick can output the audio to the headset of the supervisor. If the supervisor wishes to speak into a microphone of the headset or enter data via the numeric or action pad of the Super Sidekick, the Super Sidekick can transmit such data in a sidekick position request for the calltaker computer to act accordingly.

FIGS. 4-7B illustrated how the Super Sidekick can pair to a calltaker position. The Super Sidekick can then pair to another calltaker position by following the operations of FIGS. 5 and 7A-7B. Further, the Super Sidekick can also pair to the supervisor computer, such as by interacting with a position ID at the supervisor computer.

FIGS. 8A-8J illustrate a telephone cradle, according to an implementation of the present disclosure.

Some PSAPs provide relatively low-quality headsets to their employees due to cost concerns. The current Applicant provides a call handling system that can include higher quality handsets that output clearer audio. If the call handling system does not include a telephone cradle, the handset might slide off the desk after the handset is placed down following a call.

Various implementations of the telephone cradle illustrated in FIGS. 8A-8J can prevent the handset from sliding off the desk. In addition, the telephone cradle can release a call, when the handset is placed on a switchhook.

As shown in FIG. 8A, the telephone cradle 800 includes a shaft 810, a U-shaped member 820 at a distal end of the shaft 810, and a base 830 at a proximal end of the shaft 810.

The shaft 810 can be any shape. In the implementation illustrated in FIG. 8A, the shaft 810 has a circular cross-section. In other implementations, the shaft 810 can have a square, rectangular, triangular, or elliptical cross-section. The shaft 810 protrudes in an axial direction thereof from the base 830.

The U-shaped member 820 is constructed to hold a telephonic handset 880. Thus, the U-shaped member 820 is an example of a means for holding a telephonic handset. The U-shaped member 820 protrudes from the shaft 810. In many implementations, the U-shaped member 820 protrudes from the shaft 810 in the axial direction of the shaft 810.

In the implementation illustrated in FIG. 8A, the U-shaped member 820 includes a bottom portion, a left guide 820A, and a right guide 820B. In many implementations, the left guide 820A and the right guide 820B are separated by a distance less than the width of an earpiece of the telephonic handset 880. Some handsets have an earpiece with a width of substantially 6 cm. The left guide 820A and the right guide 820B can be separated by a distance at least as wide as the handle of the telephonic handset 880. Some handsets have a handle width of 3.2 cm.

In several implementations, the U-shaped member 820 has a pitch relative to the axial direction of the shaft 810. In many implementations, this pitch is greater than or equal to 20° and less than or equal to 70°. In select implementations, this pitch is greater than 30° and less than or equal to 60°.

The tops of the left guide 820A and the right guide 820B can be beveled. Accordingly, the calltaker can smoothly insert the telephonic handset 880 into the telephone cradle 800 and smoothly remove the telephonic handset 880 therefrom.

If the left guide 820A and/or the right guide 820B are too short, then the telephonic handset 880 can easily slide over the guides. Thus, in several implementations, the guides extend substantially 10 mm or more from the bottom portion of the U-shaped member 820. This extension can prevent the telephonic handset 880 from sliding off the left and/or right sides of the U-shaped member 820. Thus, the left guide 820A and right guide 820B are each an example of a slide-prevention means for preventing the telephonic handset from sliding off a side of the holding means.

The bottom portion of the U-shaped member 820 can include a switchhook button 840. In many implementations, the top of the switchhook button 840 has a pitch relative to the axial direction of the shaft 810 that is substantially equal to the pitch of the U-shaped member 820. The switchhook button 840 can be supported by a spring, for example. In a depressed position, the switchhook button 840 can retract into the U-shaped member 820.

In several implementations, the switchhook button 840 is located within the area of the shaft 810, when the telephone cradle 800 is viewed from above. Thus, the shaft 810 can support the contact point between the telephonic handset 880 and the switchhook button 840. In select implementations, the switchhook button 840 is located outside the area of the shaft 810.

When the telephonic handset 880 is placed into the U-shaped member 820, gravity can pull the telephonic handset 880 in the axial direction of the shaft 810. Because the U-shaped member 820 has a pitch relative to the axial direction, the telephonic handset 880 can slide down the U-shaped member 820. Further, because the left guide 820A and the right guide 820B are separated by a gap at least as wide as the handle of the telephonic handset 880, the handle of the telephonic handset 880 can slide through the gap along the U-shaped member. However, because the gap is less than the width of the earpiece of the telephonic handset 880, the earpiece does not slide through the gap. That is, in some implementations, the left guide 820A and/or the right guide 820B can support the earpiece.

In compliance with International Telecommunication Union (ITU) ITU-T Recommendation P.350, handsets commonly have a length exceeding 126 mm, excluding the earpiece. Thus, in many implementations, the U-shaped member 820 has a length of less than 126 mm, so that the earpiece and mouthpiece of the telephonic handset 880 are not supported by the U-shaped member 820.

In many implementations, the U-shaped member 820 is 100 mm or less. In various implementations, the switchhook button 840 is located in the middle of the U-shaped member 820. In one example, the switchhook button is 50 mm from the top of the bottom portion of the U-shaped member 820.

In the implementation of FIG. 8A, the switchhook button 840 has a shape intermediate between a square and a circle (a “squircle”). In other implementations, the switchhook button 840 can be a square, a circle, or any other shape.

When the telephonic handset 880 rests in the U-shaped member 820, the weight of the telephonic handset 880 depresses the switchhook button 840. When the switchhook button 840 is depressed, the telephonic handset 880 can receive a call. When the telephonic handset 880 is not resting in the U-shaped member 820 (e.g., because the telephone is in use), the switchhook button 840 protrudes from the bottom portion of the U-shaped member 820. In such a state of the switchhook button 840, the telephonic handset 880 cannot receive a call. Thus, the switchhook button 840 is an example of a disconnecting means for disconnecting a connection of the telephonic handset 880.

The U-shaped member 820 can have a contoured interior. In select implementations, this interior has a textured surface to increase sliding friction.

The base 830 can be any shape, such as square or round. In an implementation in which the base 830 is round, the base 830 can be or include a suction cup to adhere to a surface. Thus, the suction cup is an example of an adhering means for adhering to a surface.

In many implementations, this suction cup can be a bellows suction cup. A bellows suction cup is less likely to damage the surface to which it attaches (e.g., the calltaker's desk). Further, a bellows suction cup can compensate for some inaccuracies in the surface, for example, if the surface has a texture. A silicone mat is an example of such a surface. Thus, the bellows suction cup is an example of an attaching means for attaching to a textured surface.

In an implementation in which the base 830 is or includes a suction cup, the telephone cradle 800 can include a release lever 850 for the suction cup. In the implementation illustrated in FIG. 8A, the release lever 850 releases suction within the suction cup, when the release lever 850 is lifted toward the distal end of the telephone cradle 800. In other implementations, the release lever 850 can release suction, if it is turned to the left or counter-clockwise, for example. Thus, the release lever 850 is an example of a releasing means for decreasing suction of the suction cup.

In various implementations, the base 830 includes a plurality of suction cups. In such an implementation, the base 830 can include a plurality of release levers, such that each release lever can release a corresponding one of the plurality of suction cups.

In some implementations, pushing the release lever 850 downward can activate the suction. In select implementations, the release lever 850 can activate suction, if the release lever is turned to the right or clockwise, for example.

The telephone cradle 800 can communicate a plurality of signals. One such signal can indicate whether the switchhook button 840 is depressed or not.

Another signal includes the audio received from a counterparty to a telephone call, such as the content spoken by a person reporting an emergency. Another signal is the audio spoken by a calltaker during the emergency call.

To communicate these signals, the telephone cradle 800 can include a communication unit, such as a jack 860 or a wireless communication unit (not pictured).

In particular, in many implementations, the base 830 can include the jack 860 or the wireless communication unit. The jack 860 can comply with a registered jack (RJ) standard, such as RJ11, RJ14, or RJ45. A wired connection can be made from the jack 860 to a telephone line, for example.

The wireless communication unit can wirelessly communicate signals using a technology such as Bluetooth or WiFi. Thus, the interface to the telephone line can be located at the calltaker's computer or some other computer in the PSAP.

In some implementations, the telephone cradle 800 communicates signals via a cable to the telephonic handset 880. In particular, the audio output by the earpiece and the audio input by the mouthpiece can be communicated by such a cable. The cable can be attached to the telephone cradle 800 via an unpictured port in the base 830, for example.

The shaft 810 can include a contoured grip 870. The implementation illustrated in FIG. 8A includes four grooves to be gripped by the fingers of a hand of the calltaker. However, the contoured grip 870 can include fewer grooves.

In addition or alternatively, in some implementations, the contoured grip 870 includes a thumb groove on the opposite side of the shaft 810, for example. In select implementations, the thumb groove is not located at an opposite side of the shaft 810. For example, the thumb groove can be offset from a finger groove by 90°, for example.

FIG. 8A shows an implementation in which the contoured grip 870 protrudes from the shaft 810. In various implementations, the shaft 810 includes one or more recesses that form the contoured grip 870.

In particular implementations, the contoured grip 870 can be constructed to favor use by a left hand. In other implementations, the contoured grip 870 can be constructed to favor use by a right hand or of either hand.

In many implementations, the contoured grip 870 can be constructed with a different material than the shaft 810. For example, the contoured grip 870 can be constructed with a material having greater friction or greater cushioning than the shaft 810.

In use, a calltaker can obtain the telephone cradle 800 and grip it by the contoured grip 870. Thereby, the calltaker can obtain a firm grip on the shaft 810. Thus, the contoured grip 870 is an example of a gripping means for obtaining a firm grip. The calltaker can release the release lever 850. The calltaker can thrust the telephone cradle 800 downward to make contact with a hard surface, such as a desktop. In doing so, the telephone cradle 800 can compress the suction cup in the base 830. Thus, a vacuum can be created within the suction cup. The calltaker can then engage the release lever 850 to engage the suction.

The calltaker can then place the telephonic handset 880 within the U-shaped member 820. In doing so, the telephonic handset 880 can depress the switchhook button 840. Thus, the telephonic handset 880 can receive a call.

When a call is received, the calltaker lifts the telephonic handset 880 from the U-shaped member 820. Thus, the switchhook button 840 can protrude from the bottom portion of the U-shaped member 820. In this state, the telephonic handset 880 cannot receive another call by conventional means. When the calltaker returns the telephonic handset 880 within the U-shaped member 820, the telephonic handset 880 can slide into position so as to depress the switchhook button 840. Thus, the telephonic handset 880 can receive another call.

If the calltaker would like to reposition the telephone cradle 800, then the calltaker can disengage the release lever 850. Thus, the suction within the suction cup can be reduced, and the telephone cradle 800 can be more easily separated from the surface. In separating the telephone cradle 800 from the hard surface, the calltaker can again grip the contoured grip 870 to obtain a firm grip on the shaft 810.

Thus, the telephone cradle 800 can be easily installed or removed.

The broken line showing of the telephony device of FIGS. 8B-8J is for the purpose of illustrating environmental structure.

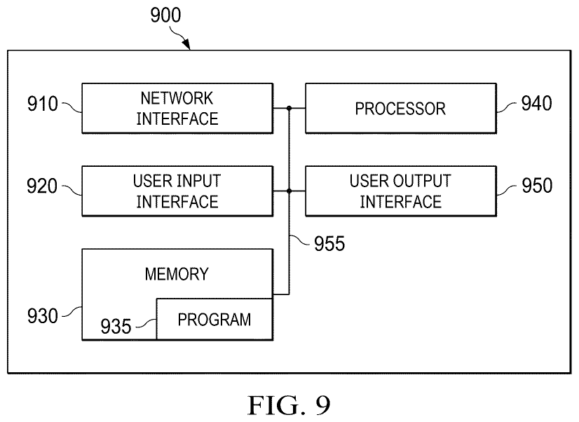

FIG. 9 illustrates a computing device 900 (e.g., a device), according to an implementation of the present disclosure. The computers at positions 120, 140 (e.g., the calltaker computer) and the computer of supervisor 160 (e.g., the supervisor computer) can be implemented by the computing device 900. Further, aspects of the Super Sidekick can be implemented by the computing device 900.

The computing device 900 can include a network interface 910, a user input interface 920, a memory 930, a program 935, a processor 940, a user output interface 950, and a bus 955.

Although illustrated within a single housing, the computing device 900 can be distributed across plural housings or sub-systems that cooperate in executing program instructions. In some implementations, the computing device 900 can include one or more blade server devices, standalone server devices, personal computers (including laptop computers and tablet computers), routers, hubs, switches, bridges, firewall devices, intrusion detection devices, mainframe computers, network-attached storage devices, smartphones and other mobile telephones, and other computing devices. Although the system executes the Windows OS, macOS, or Linux in many implementations, the system hardware can be configured according to a Symmetric Multi-Processing (SMP) architecture or a Non-Uniform Memory Access (NUMA) architecture.

The network interface 910 provides one or more communication connections and/or one or more devices that allow for communication between the computing device 900 and other computing systems (not shown) over a communication network, collection of networks (not shown), or the air, to support the telephony devices for public safety answering points, outlined herein. The network interface 910 can communicate using various networks (including both internal and external networks) such as near-field communications (NFC), Wi-Fi™, Bluetooth, Ethernet, cellular (e.g., 3G, 4G, 5G, 6G), white space, 802.11x, satellite, Bluetooth, LTE, GSM/HSPA, CDMA/EVDO, DSRC, CAN, GPS, facsimile, or any other wired or wireless interface. Other interfaces can include physical ports (e.g., Ethernet, USB, HDMI, etc.), interfaces for wired and wireless internal subsystems, and the like. Similarly, nodes and user equipment (e.g., mobile devices) of the system can also include suitable interfaces for receiving, transmitting, and/or otherwise communicating data or information in a network environment.

The user input interface 920 can receive one or more inputs from a human. The user input interface 920 can be or include a mouse, a touchpad, a keyboard, a touchscreen, a trackball, a camera, a microphone, a joystick, a game controller, a scanner, and/or any other input device.

The memory 930, also termed a “storage,” can include or be one or more computer-readable storage media readable by the processor 940 and that store software. The memory 930 can be implemented as one storage device or across multiple co-located or distributed storage devices or sub-systems. The memory 930 can include additional elements, such as a controller, that communicate with the processor 940. The memory 930 can also include storage devices and/or sub-systems on which data and/or instructions are stored. The computing device 900 can access one or more storage resources to access information to carry out any of the processes indicated in this disclosure and, in particular, FIGS. 4-7B. In various implementations, the memory 930 stores the program 935 to execute at least a portion of the algorithms illustrated in FIGS. 4-7B. Further, the program 935, when executed by the computing device 900 generally and/or the processor 940 specifically, can direct, among other functions, performance of the operations of the telephony devices for public safety answering points, as described herein.

The memory 930 can be or include a read-only memory (ROM), a programmable ROM (PROM), an erasable PROM (EPROM), an electrically erasable PROM (EEPROM), a random-access memory (RAM), a dynamic RAM (DRAM), a static RAM (SRAM), a field programmable gate array (FPGA), a hard drive, a cache memory, a flash memory, a removable disk, or a tape reel. The memory 930 can be or include resistive RAM (RRAM) or a magneto-resistive RAM (MRAM). The information being tracked, sent, received, or stored in the communication system can be provided in any database, register, table, cache, queue, control list, or storage structure, based on particular implementations, all of which could be referenced in any suitable timeframe.

The processor 940 (e.g., a processing unit) can be or include one or more hardware processors and/or other circuitry that retrieve and execute software, especially the program 935, from the memory 930. The processor 940 can be implemented within one processing device, chip, or package and can also be distributed across multiple processing devices, chips, packages, or sub-systems that cooperate. In some implementations, the processor 940 is or includes a Graphics Processing Unit (GPU).

The processor 940 can have any register size, such as a 32-bit register or a 64-bit register, among others. The processor 940 can include multiple cores. Implementations of the processor 940 are not limited to any particular number of threads. The processor 940 can be fabricated by any process technology, such as 14 nm process technology.

The user output interface 950 outputs information to a human user. The user output interface 950 can be or include a display (e.g., a screen), a touchscreen, speakers, a printer, or a haptic feedback unit. In many implementations, the user output interface 950 can be combined with the user input interface 920. For example, some such implementations include a touchscreen, a headset including headphones and a microphone, or a joystick with haptic feedback.

In implementations including multiple computing devices, a server of the system or, in a serverless implementation, a peer can use one or more communications networks that facilitate communication among the computing devices to achieve the operation of the telephony devices for public safety answering points, as outlined herein. For example, the one or more communications networks can include or be a local area network (LAN) or wide area network (WAN) that facilitate communication among the computing devices. One or more direct communication links can be included between the computing devices. In addition, in some cases, the computing devices can be installed at geographically distributed locations. In other cases, the multiple computing devices can be installed at one geographic location, such as a server farm or an office.

As used herein, the terms “storage media” or “computer-readable storage media” can refer to non-transitory storage media, such as non-limiting examples of a hard drive, a memory chip, an ASIC, and cache memory, and to transitory storage media, such as carrier waves or propagating signals.

Aspects of the system can be implemented in various manners, e.g., as a method, a system, a computer program product, or one or more computer-readable storage media. Accordingly, aspects of the present disclosure can take the form of a hardware implementation, a software implementation (including firmware, resident software, or micro-code) or an implementation combining software and hardware aspects that can generally be referred to herein as a “module” or a “system.” Functions described in this disclosure can be implemented as an algorithm executed by one or more hardware processing units, e.g., the processor 940. In various embodiments, different operations and portions of the operations of the algorithms described can be performed by different processing units. In some implementations, the operations can be achieved by reciprocating software in any of the computers at positions 120, 140 (e.g., the calltaker computer) and the computer of supervisor 160 (e.g., the supervisor computer). Furthermore, aspects of the present disclosure can take the form of a computer program product embodied in one or more computer-readable media having computer-readable program code embodied, e.g., encoded or stored, thereon. In various implementations, such a computer program can, for example, be downloaded (or updated) to existing devices and systems or be stored upon manufacture of these devices and systems.

Any suitable permutation can be applied to a physical implementation, including the design of the communications network in which the system is implemented. In one embodiment, the bus 955 can share hardware resources with the memory 930 and the processor 940. In this alternative implementation, the computing device 900 can be provided with separate hardware resources including one or more processors and memory elements.

In example implementations, various other components of the computing device 900 can be installed in different physical areas or can be installed as single units.

The broad terms “device,” “computing device,” and “telephony device” encompass any type of node, endpoint, equipment, or machine capable of performing at least some of the operations or possessing some of the structures of FIGS. 4-8 detailed herein. By way of example, such devices can include (but are not limited to) elements such as a computer, a personal digital assistant (PDA), a laptop or electronic notebook, a cellular telephone, an IP telephone, an iPhone™, an iPad™, a Microsoft Surface™, an Android™ phone, a Google Nexus™, or any other device, component, element, or object capable of initiating voice, audio, or data exchanges within a network or a communication system. The devices can include a suitable interface such as a microphone, a display, a keyboard, a tactile surface, a pad, or other suitable terminal equipment. The term “device” includes any object that seeks to receive a communication on behalf of another entity or element, such as a program, a database, a proxy, or any other component or element capable of initiating an exchange within a communication framework. This includes the use of AI and ML implemented by (or on behalf of) a device. In addition, any of the devices could be a proprietary device designed for the communications discussed herein.

The communication system can be configured to facilitate communication with machine devices (e.g., vehicle sensors, instruments, electronic control units (ECUs), embedded devices, actuators, displays, etc.) through the bus 955. Other suitable communication interfaces can also be provided for an Internet Protocol (IP) network, a user datagram protocol (UDP) network, or any other suitable protocol or communication architecture enabling network communication with machine devices.

The innovations in this detailed description can be implemented in a multitude of different ways, for example, as defined and covered by the claims and/or select examples. In the description, reference is made to the drawings where like reference numerals can indicate identical or functionally similar elements. Elements illustrated in the drawings are not necessarily drawn to scale. Additionally, certain implementations can include more elements than illustrated in a drawing and/or a subset of the elements illustrated in a drawing. Further, some implementations can incorporate a suitable combination of features from two or more drawings.

The disclosure describes various illustrative implementations and examples for implementing the features and functionality of the present disclosure. The components, arrangements, and/or features are described in connection with various implementations and are merely examples to simplify the present disclosure and are not intended to be limiting. In the development of actual implementations, implementation-specific decisions can be made to achieve specific goals, including compliance with system, business, and/or legal constraints, which can vary from one implementation to another. Additionally, while such a development effort might be complex and time-consuming, it would be a routine undertaking for those of ordinary skill in the art having the benefit of this disclosure.

The systems, methods and devices of this disclosure have several innovative aspects, no one of which is solely responsible for the attributes disclosed herein. Some objects or advantages might not be achieved by implementations described herein. Thus, for example, certain implementations can operate in a manner that achieves or optimizes one advantage or group of advantages as taught herein and not other objects or advantages as taught or suggested herein.

In one example implementation, electrical circuits of the drawings can be implemented on a board of an associated electronic device. The board can be a general circuit board that can hold various components of the internal electronic system of the electronic device and, further, provide connectors for other peripherals. More specifically, the board can provide the electrical connections by which other components of the system can communicate electrically. Any processors (inclusive of digital signal processors, microprocessors, supporting chipsets, etc.) and computer-readable, non-transitory memory elements can be coupled to the board based on configurations, processing demands, and computer designs. Other components such as external storage, additional sensors, controllers for audio/video display, and peripheral devices can be attached to the board as plug-in cards, via cables, or integrated into the board itself. In various implementations, the functionalities described herein can be implemented in emulation form as software or firmware running within one or more configurable (e.g., programmable) elements arranged in a structure that supports these functions. A non-transitory, computer-readable storage medium can include instructions to allow one or more processors to carry out the emulation.

In another example implementation, the electrical circuits of the drawings can be implemented as stand-alone modules (e.g., a device with associated components and circuitry configured to perform a specific application or function) or implemented as plug-in modules into application specific hardware of electronic devices. Implementations of the present disclosure can be readily included in a system-on-chip (SOC) package. An SOC represents an integrated circuit (IC) that integrates components of a computer or other electronic system into one chip. The SOC can contain digital, analog, mixed-signal, and often radio frequency functions on one chip substrate. Other implementations can include a multi-chip-module (MCM), with a plurality of separate ICs located within one electronic package and that interact through the electronic package. In various other implementations, the processors can be implemented in one or more silicon cores in Application Specific Integrated Circuits (ASICs), Field Programmable Gate Arrays (FPGAs), programmable array logic (PAL), generic array logic (GAL), and other semiconductor chips.

The specifications, dimensions, and relationships outlined herein (e.g., the number of processors and logic operations) have been offered for non-limiting purposes of example and teaching. For example, various modifications and changes can be made to the arrangements of components. The description and drawings are, accordingly, to be regarded in an illustrative sense, not in a restrictive sense.

The numerous examples provided herein described interaction in terms of two, three, or more electrical components for purposes of clarity and example. The system can be consolidated in any manner. Along similar design alternatives, the illustrated components, modules, and elements of the drawings can be combined in various possible configurations within the scope of this disclosure. In certain cases, one or more of the functionalities of a given set of flows might be more clearly described by referencing a limited number of electrical elements. The electrical circuits of the drawings are readily scalable and can accommodate many components, as well as more complicated/sophisticated arrangements and configurations. Accordingly, the provided examples do not limit the scope or inhibit the teachings of the electrical circuits as potentially applied to a myriad of other architectures.

In this disclosure, references to various features (e.g., elements, structures, modules, components, steps, operations, characteristics, etc.) included in “one implementation,” “example implementation,” “an implementation,” “another implementation,” “some implementations,” “various implementations,” “other implementations,” “alternative implementation,” and the like are intended to mean that any such features can be included in one or more implementations of the present disclosure and might or might not necessarily be combined in the same implementations. Some operations can be deleted or omitted where appropriate, or these operations can be modified or changed considerably. In addition, the timing of these operations can be altered considerably. The preceding operational flows have been offered for purposes of example and discussion. Implementations described herein provide flexibility in that any suitable arrangements, chronologies, configurations, and timing mechanisms can be provided.

### EXAMPLES

In Example AM1, a method is implemented by a device and includes receiving a position ID; determining whether a first input was received on a first pad of the device within a predetermined period of the receiving; transmitting a device communication request via a first wireless connection of the device, wherein the device communication request indicates the position ID; and receiving, via the first wireless connection, a communication response including audio of a telephone call.

Example AM2 is the method of Example AM1, further comprising: transmitting a position request via a second wireless connection, wherein the position ID is received via the second wireless connection.

Example AM3 is the method of Example AM2, wherein the second wireless connection complies with a near-field communication (NFC) protocol.

Example AM4 is the method of any of Examples AM1-AM3, wherein the position ID is received by capturing an image and by determining the position ID at least in part based on the image.

Example AM5 is the method of any of Examples AM1-AM4, further comprising: transmitting a registration request indicating a device ID of the device; and receiving a registration response, wherein the communication request indicates the device ID.

Example AM6 is the method of any of Examples AM1-AM5, further comprising: receiving a second input on a second pad of the device; and transmitting an indication of the second input via the first wireless connection.

Example AM7 is the method of any of Examples AM1-AM6, further comprising: outputting the audio via a headphone jack or a wireless communication unit.

In Example AA1, an apparatus comprises: a first pad; a processor configured to determine whether a first input was received on the first pad within a predetermined period of a reception of a position ID; and a network interface that transmits a device communication request via a first wireless connection of the apparatus, wherein the device communication request indicates the position ID, and the network interface receives, via the first wireless connection, a communication response including audio of a telephone call.

Example AA2 is the apparatus of Example AA1, wherein the network interface transmits a position request via a second wireless connection, wherein the position ID is received via the second wireless connection.

Example AA3 is the apparatus of Example AA2, wherein the second wireless connection complies with a near-field communication (NFC) protocol.

Example AA4 is the apparatus of any of Examples AA1-AA3, wherein the position ID is received by capturing an image and by determining the position ID at least in part based on the image.

Example AA5 is the apparatus of any of Examples AA1-AA4, wherein the network interface transmits a registration request indicating a device ID of the apparatus and receives a registration response, and the communication request indicates the device ID.

Example AA6 is the apparatus of any of Examples AA1-AA5, further comprising: a second pad that receives a second input, wherein the network interface transmits an indication of the second input via the first wireless connection.

Example AA7 is the apparatus of any of Examples AA1-AA6, further comprising: a headphone jack or a wireless communication unit to output the audio.

In Example AC1, a computer-readable medium includes instructions that, when executed by a processor of a device, perform operations comprising: receiving a position ID; determining whether a first input was received on a first pad of the device within a predetermined period of the receiving; transmitting a device communication request via a first wireless connection of the device, wherein the device communication request indicates the position ID; and receiving, via the first wireless connection, a communication response including audio of a telephone call.

Example AC2 is the medium of Example AC1, the operations further comprising: transmitting a position request via a second wireless connection, wherein the position ID is received via the second wireless connection.

Example AC3 is the medium of Example AC2, wherein the second wireless connection complies with a near-field communication (NFC) protocol.

Example AC4 is the medium of any of Examples AC1-AC3, wherein the position ID is received by capturing an image and by determining the position ID at least in part based on the image.

Example AC5 is the medium of any of Examples AC1-AC4, the operations further comprising: transmitting a registration request indicating a device ID of the device; and receiving a registration response, wherein the communication request indicates the device ID.

Example AC6 is the medium of any of Examples AC1-AC5, the operations further comprising: receiving a second input on a second pad of the device; and transmitting an indication of the second input via the first wireless connection.

Example AC7 is the medium of any of Examples AC1-AC6, further comprising: outputting the audio via a headphone jack or a wireless communication unit.

In Example AF1, an apparatus includes inputting means for receiving a first input; interfacing means for performing a reception of a position ID; and processing means for determining whether a first input was received on the inputting means within a predetermined period of the reception, wherein the interfacing means transmits a device communication request via a first wireless connection, the device communication request indicates the position ID, and the interfacing means receives, via the first wireless connection, a communication response including audio of a telephone call.

Example AF2 is the apparatus of Example AF1, wherein the networking means transmits a position request via a second wireless connection, and the position ID is received via the second wireless connection.

Example AF3 is the apparatus of Example AF2, wherein the second wireless connection complies with a near-field communication (NFC) protocol.

Example AF4 is the apparatus of any of Examples AF1-AF3, further comprising: means for capturing an image, wherein the position ID is received by capturing the image and by determining the position ID at least in part based on the image.

Example AF5 is the apparatus of any of Examples AF1-AF4, wherein the networking means transmits a registration request indicating a device ID of the apparatus and receives a registration response, and the communication request indicates the device ID.

Example AF6 is the apparatus of any of Examples AF1-AF5, wherein the inputting means receives a second input, and the networking means transmits an indication of the second input via the first wireless connection.

Example AF7 is the apparatus of any of Examples AF1-AF6, further comprising: means for outputting the audio.

In Example BM1, a method is implemented by a device and includes receiving a communication request via a wireless connection, wherein the communication request indicates a position of a telephone call and a device ID; determining whether the device ID matches a predetermined device ID; and transmitting, via the wireless connection, a communication response to the communication request, the communication response including audio of the telephone call.

Example BM2 is the method of Example BM1, further comprising: receiving a headset registration request identifying a device ID of a headset, wherein the communication response is transmitted at least in part based on the device ID of the headset.

Example BM3 is the method of any of Examples BM1-BM2, further comprising: determining whether a login at the device was authenticated, wherein the transmitting is at least in part based on the determining.

Example BM4 is the method of any of Examples BM1-BM3, further comprising: receiving a voice input via the wireless connection; and applying the voice input to the telephone call.

Example BM5 is the method of any of Examples BM1-BM4, further comprising: receiving an indication of a numeric input via the wireless connection, wherein a dual-tone multi-frequency (DTMF) tone is generated, at least in part based on the numeric input; and applying the DTMF tone to the telephone call.

Example BM6 is the method of any of Examples BM1-BM5, further comprising: receiving an indication of an action via the wireless connection; and performing the action on the telephone call.

Example BM7 is the method of any of Examples BM1-BM6, further comprising: receiving a registration request indicating the predetermined device ID.

In Example BA1, an apparatus includes a network interface that receives a communication request via a wireless connection, wherein the communication request indicates a position of a telephone call and a device ID of a device; and a processor configured to perform a determination whether the device ID matches a predetermined device ID, wherein the network interface transmits, via the wireless connection, a communication response to the communication request, the communication response including audio of the telephone call.

Example BA2 is the apparatus of Example BA1, wherein the network interface receives a headset registration request identifying a device ID of a headset, and the communication response is transmitted at least in part based on the device ID of the headset.

Example BA3 is the apparatus of any of Examples BA1-B2, wherein the processor is further configured to determine whether a login at the apparatus was authenticated, and the transmitting is at least in part based on the determination.

Example BA4 is the apparatus of any of Examples BA1-BA3, wherein the network interface receives a voice input via the wireless connection, and the voice input is applied to the telephone call.

Example BA5 is the apparatus of any of Examples BA1-BA4, wherein the network interface receives an indication of a numeric input via the wireless connection, a dual-tone multi-frequency (DTMF) tone is generated, at least in part based on the numeric input, and the DTMF tone is applied to the telephone call.

Example BA6 is the apparatus of any of Examples BA1-BA5, wherein the network interface receives an indication of an action via the wireless connection, and the action is performed on the telephone call.

Example BA7 is the apparatus of any of Examples BA1-BA6, wherein the network interface receives a registration request indicating the predetermined device ID.

In Example BC1, a computer-readable medium includes instructions that, when executed by a processor, perform operations comprising: receiving a communication request via a wireless connection, wherein the communication request indicates a position of a telephone call and a device ID of a device; performing a determination whether the device ID matches a predetermined device ID; and transmitting, via the wireless connection, a communication response to the communication request, the communication response including audio of the telephone call.

Example BC2 is the medium of Example BC1, the operations further comprising: receiving a headset registration request identifying a device ID of a headset, wherein the communication response is transmitted at least in part based on the device ID of the headset.

Example BC3 is the medium of any of Examples BC1-BC2, the operations further comprising: determining whether a login at the apparatus was authenticated, wherein the transmitting is at least in part based on the determination.

Example BC4 is the medium of any of Examples BC1-BC3, the operations further comprising: receiving a voice input via the wireless connection; and applying the voice input to the telephone call.

Example BC5 is the medium of any of Examples BC1-BC4, the operations further comprising: receiving an indication of a numeric input via the wireless connection, wherein a dual-tone multi-frequency (DTMF) tone is generated, at least in part based on the numeric input; and applying the DTMF tone to the telephone call.

Example BC6 is the medium of any of Examples BC1-BC5, the operations further comprising: receiving an indication of an action via the wireless connection; and performing the action on the telephone call.

Example BC7 is the medium of any of Examples BC1-BC6, the operations further comprising: receiving a registration request indicating the predetermined device ID.

In Example BF1, an apparatus includes networking means for receiving a communication request via a wireless connection, wherein the communication request indicates a position of a telephone call and a device ID; and processing means for determining whether the device ID matches a predetermined device ID, wherein the networking means transmit, via the wireless connection, a communication response to the communication request, the communication response including audio of the telephone call.

Example BF2 is the apparatus of Example BF1, wherein the networking means receive a headset registration request identifying a device ID of a headset, and the communication response is transmitted at least in part based on the device ID of the headset.

Example BF3 is the apparatus of any of Examples BF1-BF2, wherein the processing means perform a determination whether a login at the device was authenticated, and the transmitting is at least in part based on the determination.

Example BF4 is the apparatus of any of Examples BF1-BF3, wherein the networking means receive a voice input via the wireless connection, and the voice input is applied to the telephone call.

Example BF5 is the apparatus of any of Examples BF1-BF4, wherein the networking means receive an indication of a numeric input via the wireless connection, a dual-tone multi-frequency (DTMF) tone is generated, at least in part based on the numeric input, and the DTMF tone is applied to the telephone call.

Example BF6 is the apparatus of any of Examples BF1-BF5, wherein the networking means receive an indication of an action via the wireless connection, and the action is performed on the telephone call.

Example BF7 is the apparatus of any of Examples BF1-BF6, wherein the networking means receive a registration request indicating the predetermined device ID.

In Example CM1, a method is implemented by a first device and includes receiving a supervisor ID via a first wireless technology; determining whether a device ID of a second device was received via a second wireless technology; and transmitting a position communication request via the first wireless technology, the communication request indicating the device ID, the supervisor ID, and a position ID of the first device, wherein audio of a telephone call is transmitted via the first wireless technology, at least in part based on the device ID.

Example CM2 is the method of Example CM1, further comprising: transmitting a low-power request via the second wireless technology, wherein the first wireless technology is Bluetooth or WiFi, and the second wireless technology complies with a near-field communication (NFC) protocol.

Example CM3 is the method of any of Examples CM1-CM2, further comprising: establishing a position connection via the first wireless technology, at least in part based on the device ID of the second device.

Example CM4 is the method of any of Examples CM1-CM3, further comprising: receiving a position communication response via the first wireless technology, wherein the audio of the telephone call is transmitted at least in part based on a determination whether the position communication response was received.

Example CM5 is the method of any of Examples CM1-CM4, further comprising: receiving a device position request indicating an action via the first wireless technology, wherein the action is performed on the telephone call.

Example CM6 is the method of any of Examples CM1-CM5, further comprising: receiving a device position request indicating a numeric input via the first wireless technology, wherein a dual-tone multi-frequency (DTMF) tone is generated, at least in part based on the numeric input.

Example CM7 is the method of any of Examples CM1-CM6, further comprising: receiving a device position request indicating an audio signal, wherein the audio signal is applied to the telephone call.

In Example CA1, an apparatus includes a network interface that receives a supervisor ID via a first wireless technology; and a processor configured to determine whether a device ID of a device was received via a second wireless technology, wherein the network interface transmits a position communication request via the first wireless technology, the communication request indicating the device ID, the supervisor ID, and a position ID of the apparatus, and audio of a telephone call is transmitted via the first wireless technology, at least in part based on the device ID.

Example CA2 is the apparatus of Example CA1, wherein the network interface transmits a low-power request via the second wireless technology, the first wireless technology is Bluetooth or WiFi, and the second wireless technology complies with a near-field communication (NFC) protocol.

Example CA3 is the apparatus of any of Examples CA1-CA2, wherein the network interface establishes a position connection via the first wireless technology, at least in part based on the device ID of the second device.

Example CA4 is the apparatus of any of Examples C1-C3, wherein the network interface receives a position communication response via the first wireless technology, and the audio of the telephone call is transmitted at least in part based on a determination whether the position communication response was received.

Example CA5 is the apparatus of any of Examples CA1-CA4, wherein the network interface receives a device position request indicating an action via the first wireless technology, and the action is performed on the telephone call.

Example CA6 is the apparatus of any of Examples CA1-CA5, wherein the network interface receives a device position request indicating a numeric input via the first wireless technology, and a dual-tone multi-frequency (DTMF) tone is generated, at least in part based on the numeric input.

Example CA7 is the apparatus of any of Examples CA1-CA6, wherein the network interface receives a device position request indicating an audio signal, and the audio signal is applied to the telephone call.

In Example CC1, a computer-readable medium includes instructions that, when executed by a processor of a first device, perform operations including receiving a supervisor ID via a first wireless technology; determining whether a device ID of a second device was received via a second wireless technology; and transmitting a position communication request via the first wireless technology, the communication request indicating the device ID, the supervisor ID, and a position ID of the first device, wherein audio of a telephone call is transmitted via the first wireless technology, at least in part based on the device ID.

Example CC2 is the medium of Example CC1, the operations further comprising: transmitting a low-power request via the second wireless technology, wherein the first wireless technology is Bluetooth or WiFi, and the second wireless technology complies with a near-field communication (NFC) protocol.

Example CC3 is the medium of any of Examples CC1-CC2, the operations further comprising: establishing a position connection via the first wireless technology, at least in part based on the device ID of the second device.

Example CC4 is the medium of any of Examples CC1-CC3, the operations further comprising: receiving a position communication response via the first wireless technology, wherein the audio of the telephone call is transmitted at least in part based on a determination whether the position communication response was received.

Example CC5 is the medium of any of Examples CC1-CC4, the operations further comprising: receiving a device position request indicating an action via the first wireless technology, wherein the action is performed on the telephone call.

Example CC6 is the medium of any of Examples CC1-CC5, the operations further comprising: receiving a device position request indicating a numeric input via the first wireless technology, wherein a dual-tone multi-frequency (DTMF) tone is generated, at least in part based on the numeric input.

Example CC7 is the medium of any of Examples CC1-CC5, the operations further comprising: receiving a device position request indicating an audio signal, wherein the audio signal is applied to the telephone call.

In Example CF1, an apparatus includes networking means for receiving a supervisor ID via a first wireless technology; and processing means for determining whether a device ID of a second device was received via a second wireless technology, wherein the networking means transmits a position communication request via the first wireless technology, the communication request indicating the device ID, the supervisor ID, and a position ID of the first device, and audio of a telephone call is transmitted via the first wireless technology, at least in part based on the device ID.

Example CF2 is the apparatus of Example CF1, wherein the networking means transmits a low-power request via the second wireless technology, the first wireless technology is Bluetooth or WiFi, and the second wireless technology is near field communication (NFC).

Example CF3 is the apparatus of any of Examples CF1-CF2, wherein the networking means establishes a position connection via the first wireless technology, at least in part based on the device ID of the device.

Example CF4 is the apparatus of any of Examples CF1-CF3, wherein the networking means receives a position communication response via the first wireless technology, and the audio of the telephone call is transmitted at least in part based on a determination whether the position communication response was received.

Example CF5 is the apparatus of any of Examples CF1-CF4, wherein the networking means receives a device position request indicating an action via the first wireless technology, and the action is performed on the telephone call.

Example CF6 is the apparatus of any of Examples CF1-CF5, wherein the networking means receives a device position request indicating a numeric input via the first wireless technology, and a dual-tone multi-frequency (DTMF) tone is generated, at least in part based on the numeric input.

Example CF7 is the apparatus of any of Examples CF1-CF6, wherein the networking means receives a device position request indicating an audio signal, and the audio signal is applied to the telephone call.

In Example DM1, a method is implemented by a first device and includes receiving a device registration response via a first wireless technology, the device registration response including an address of a supervisor computer; transmitting a low-power response via a second wireless technology, the low-power response indicating a first device ID of the first device, wherein the second wireless technology uses less power than the first wireless technology; transmitting an operation authorization via the first wireless technology, the operation authorization indicating the first device ID and the address of the supervisor computer; receiving an action input on an action key of the first device; and transmitting a position request via the first wireless technology, the position request including an indication of the action input and an indication of the first device ID.

Example DM2 is the method of Example DM1, further comprising: receiving audio of a telephone call via the first wireless technology; and outputting the audio of the telephone call via a headphone jack or a wireless communication unit of the first device.

Example DM3 is the method of Example DM2, further comprising: receiving a voice input; and transmitting an indication of the voice input via the first wireless technology.

Example DM4 is the method of any of Examples DM1-DM3, further comprising: receiving a numeric input on a numeric key of the first device; and transmitting an indication of the numeric input via the first wireless technology, wherein a dual-tone multi-frequency (DTMF) tone is generated, at least in part based on the numeric input.

Example DM5 is the method of any of Examples DM1-DM4, further comprising: establishing a position connection with a second device, via the first wireless technology; and receiving a second device ID of the second device via the first wireless technology, wherein the position request is at least in part based on the second device ID.

Example DM6 is the method of any of Examples DM1-DM5, further comprising: receiving a low-power request via the second wireless technology, wherein the first wireless technology is Bluetooth or WiFi, and the second wireless technology complies with a near-field communication (NFC) protocol.

Example DM7 is the method of any of Examples DM1-DM6, further comprising: transmitting a device registration request via the first wireless technology, the device registration request indicating the first device ID.

In Example DA1, an apparatus includes a first pad including an action key; and a network interface that receives a device registration response via a first wireless technology, the device registration response including an address of a supervisor computer, wherein the network interface transmits a low-power response via a second wireless technology, the low-power response indicating a first device ID of the first device, the second wireless technology uses less power than the first wireless technology, the network interface transmits an operation authorization via the first wireless technology, the operation authorization indicating the first device ID and the address of the supervisor computer, the network interface receives an action input on the action key, and the network interface transmits a position request via the first wireless technology, the position request including an indication of the action input and an indication of the first device ID.

Example DA2 is the apparatus of Example DA1, further comprising: a headphone jack or a wireless communication unit that outputs audio of a telephone call, wherein the network interface receives the audio of the telephone call via the first wireless technology.

Example DA3 is the apparatus of Example DA2, wherein the apparatus receives a voice input, and the network interface transmits an indication of the voice input via the first wireless technology.

Example DA4 is the apparatus of any of Examples DA1-DA3, wherein the apparatus receives a numeric input on a numeric key of a second pad, wherein the network interface transmits an indication of the numeric input via the first wireless technology, and a dual-tone multi-frequency (DTMF) tone is generated, at least in part based on the numeric input.

Example DA5 is the apparatus of any of Examples DA1-DA4, wherein the network interface establishes a position connection with a second device, via the first wireless technology, the network interface receives a second device ID of the second device via the first wireless technology, and the position request is at least in part based on the second device ID.

Example DA6 is the apparatus of any of Examples DA1-DA5, wherein the network interface receives a low-power request via the second wireless technology, the first wireless technology is Bluetooth or WiFi, and the second wireless technology complies with a near-field communication (NFC) protocol.

Example DA7 is the apparatus of any of Examples DA1-DA6, wherein the network interface transmits a device registration request via the first wireless technology, the device registration request indicating the first device ID.

In Example DC1, a computer-readable medium includes instructions that, when executed by a first device including a processor, perform operations including receiving a device registration response via a first wireless technology, the device registration response including an address of a supervisor computer; transmitting a low-power response via a second wireless technology, the low-power response indicating a first device ID of the first device, wherein the second wireless technology uses less power than the first wireless technology; transmitting an operation authorization via the first wireless technology, the operation authorization indicating the first device ID and the address of the supervisor computer; receiving an action input on an action key of the first device; and transmitting a position request via the first wireless technology, the position request including an indication of the action input and an indication of the first device ID.

Example DC2 is the medium of Example DC1, the operations further comprising: receiving audio of a telephone call via the first wireless technology; and outputting the audio of the telephone call via a headphone jack or a wireless communication unit of the first device.

Example DC3 is the medium of Example DC2, the operations further comprising: receiving a voice input; and transmitting an indication of the voice input via the first wireless technology.

Example DC4 is the medium of any of Examples DC1-DC3, the operations further comprising: receiving a numeric input on a numeric key of the first device; and transmitting an indication of the numeric input via the first wireless technology, wherein a dual-tone multi-frequency (DTMF) tone is generated, at least in part based on the numeric input.

Example DC5 is the medium of any of Examples DC1-DC4, the operations further comprising: establishing a position connection with a second device, via the first wireless technology; and receiving a second device ID of the second device via the first wireless technology, wherein the position request is at least in part based on the second device ID.

Example DC6 is the medium of any of Examples DC1-DC5, the operations further comprising: receiving a low-power request via the second wireless technology, wherein the first wireless technology is Bluetooth or WiFi, and the second wireless technology complies with a near-field communication (NFC) protocol.

Example DC7 is the medium of any of Examples DC1-DC6, the operations further comprising: transmitting a device registration request via the first wireless technology, the device registration request indicating the first device ID.

In Example DF1, an apparatus includes inputting means for receiving an action input; and networking means for receiving a device registration response via a first wireless technology, the device registration response including an address of a supervisor computer, wherein the networking means transmits a low-power response via a second wireless technology, the low-power response indicating a first device ID of the first device, the second wireless technology uses less power than the first wireless technology, the networking means transmits an operation authorization via the first wireless technology, the operation authorization indicating the first device ID and the address of the supervisor computer, and the networking means transmits a position request via the first wireless technology, the position request including an indication of the action input and an indication of the first device ID.

Example DF2 is the apparatus of Example DF1, further comprising: means for outputting audio of a telephone call, wherein the networking means receives the audio of the telephone call via the first wireless technology.

Example DF3 is the apparatus of Example DF2, further comprising: means for receiving a voice input, wherein the networking means transmits an indication of the voice input via the first wireless technology.

Example DF4 is the apparatus of any of Examples DF1-DF3, wherein the inputting means receives a numeric input, the networking means transmits an indication of the numeric input via the first wireless technology, and a dual-tone multi-frequency (DTMF) tone is generated, at least in part based on the numeric input.

Example DF5 is the apparatus of any of Examples DF1-DF4, wherein the networking means establishes a position connection with a second device, via the first wireless technology, the networking means receives a second device ID of the second device via the first wireless technology, and the position request is at least in part based on the second device ID.

Example DF6 is the apparatus of any of Examples DF1-DF5, wherein the networking means receives a low-power request via the second wireless technology, the first wireless technology is Bluetooth or WiFi, and the second wireless technology complies with a near-field communication (NFC) protocol.

Example DF7 is the apparatus of any of Examples DF1-DF6, wherein the networking means transmits a device registration request via the first wireless technology, the device registration request indicating the first device ID.

In Example PN1, an apparatus includes a shaft extending in an axial direction thereof; a U-shaped member at a distal end of the shaft, the U-shaped member constructed to hold a telephonic handset; a switchhook button configured to disconnect a connection of the telephonic handset; and a base at a proximal end of the shaft.

Example PN2 is the apparatus of Example PN1, wherein the base includes a suction cup.

Example PN3 is the apparatus of Example PN2, further comprising: a release lever to decrease suction of the suction cup.

Example PN4 is the apparatus of any of Examples PN2-PN3, wherein the suction cup is a bellows suction cup.

Example PN5 is the apparatus of any of Examples PN1-PN4, wherein the U-shaped member includes a bottom portion and a plurality of guides, the plurality of guides protruding from the bottom portion at least partially in the axial direction.

Example PN6 is the apparatus of any of Examples PN1-PN5, wherein the switchhook button is in the U-shaped member.

Example PN7 is the apparatus of any of Examples PN1-PN6, wherein the shaft includes a contoured grip including at least one groove.

In Example PM1, an apparatus includes a shaft extending in an axial direction thereof; holding means for holding a telephonic handset, the holding means at a distal end of the shaft; disconnecting means for disconnecting a connection of the telephonic handset; and a base at a proximal end of the shaft.

Example PM2 is the apparatus of Example PM1, wherein the base includes adhering means for adhering to a surface.

Example PM3 is the apparatus of Example PM2, further comprising: releasing means for decreasing suction of the adhering means.

Example PM4 is the apparatus of any of Examples PM2-PM3, wherein the adhering means includes attaching means for attaching to a textured surface.

Example PM5 is the apparatus of any of Examples PM1-PM4, wherein the holding means includes a bottom portion and slide-prevention means for preventing the telephonic handset from sliding off a side of the holding means, the slide-prevention means protruding from the bottom portion at least partially in the axial direction.

Example PM6 is the apparatus of any of Examples PM1-PM5, wherein the disconnecting means is in the holding means.

Example PM7 is the apparatus of any of Examples PM1-PM6, wherein the shaft includes gripping means for obtaining a firm grip.

1-20. (canceled)

21. A method implemented by a computing device, the method comprising:
receiving a communication request via a wireless connection, wherein the communication request indicates a position of a telephone call and a device ID of another device;
determining whether the device ID matches a predetermined device ID; and
transmitting, via the wireless connection, a communication response to the communication request, the communication response including audio of the telephone call.

22. The method of claim 21, further comprising:
receiving a headset registration request identifying a device ID of a headset, wherein the communication response is transmitted at least in part based on the device ID of the headset.

23. The method of claim 21, further comprising:
determining whether a login at the computing device was authenticated, wherein the transmitting is at least in part based on the determining that the login was authenticated.

24. The method of claim 21, further comprising:
receiving a voice input via the wireless connection; and
applying the voice input to the telephone call.

25. The method of claim 21, further comprising:
receiving an indication of a numeric input via the wireless connection, wherein a dual-tone multi-frequency (DTMF) tone is generated, at least in part based on the numeric input; and
applying the DTMF tone to the telephone call.

26. The method of claim 21, further comprising:
receiving an indication of an action via the wireless connection; and
performing the action on the telephone call.

27. The method of claim 21, further comprising:
receiving a registration request indicating the predetermined device ID.

28. An apparatus, comprising:
a network interface that receives a communication request via a wireless connection, wherein the communication request indicates a position of a telephone call and a device ID of a device; and
a processor configured to determine whether the device ID matches a predetermined device ID, wherein
the network interface performs a transmission, via the wireless connection, of a communication response to the communication request, the communication response including audio of the telephone call.

29. The apparatus of claim 28, wherein the network interface receives a headset registration request identifying a device ID of a headset, and the communication response is transmitted at least in part based on the device ID of the headset.

30. The apparatus of claim 28, wherein the processor is further configured to perform a determination whether a login at the apparatus was authenticated, and the transmission is at least in part based on the determination.

31. The apparatus of claim 28, wherein the network interface receives a voice input via the wireless connection, and the voice input is applied to the telephone call.

32. The apparatus of claim 28, wherein the network interface receives an indication of a numeric input via the wireless connection, a dual-tone multi-frequency (DTMF) tone is generated, at least in part based on the numeric input, and the DTMF tone is applied to the telephone call.

33. The apparatus of claim 28, wherein the network interface receives an indication of an action via the wireless connection, and the action is performed on the telephone call.

34. The apparatus of claim 28, wherein the network interface receives a registration request indicating the predetermined device ID.

35. A computer-readable medium including instructions that, when executed by a processor of an apparatus, perform operations comprising:
receiving a communication request via a wireless connection, wherein the communication request indicates a position of a telephone call and a device ID of a device;
determining whether the device ID matches a predetermined device ID; and
transmitting, via the wireless connection, a communication response to the communication request, the communication response including audio of the telephone call.

36. The medium of claim 35, the operations further comprising:
receiving a headset registration request identifying a device ID of a headset, wherein the communication response is transmitted at least in part based on the device ID of the headset.

37. The medium of claim 35, the operations further comprising:
performing a determination whether a login at the apparatus was authenticated, wherein the transmitting is at least in part based on the determination.

38. The medium of claim 35, the operations further comprising:
receiving a voice input via the wireless connection; and
applying the voice input to the telephone call.

39. The medium of claim 35, the operations further comprising:
receiving an indication of a numeric input via the wireless connection, wherein a dual-tone multi-frequency (DTMF) tone is generated, at least in part based on the numeric input; and
applying the DTMF tone to the telephone call.

40. The medium of claim 35, the operations further comprising:
receiving an indication of an action via the wireless connection; and
performing the action on the telephone call.
